(19) United States
(12) Patent Application Publication
(10) Pub. No.: US 2002/0042750 A1
(43) Pub. Date: Apr. 11, 2002

(54) System method and article of manufacture for a visual self calculating order system over the world wide web

(76) Inventor: Douglas C. Morrison, Calgary (CA)

Correspondence Address: Douglas C. Morrison, 2115 25 Ave. N.W., Calgary, AB, T2M 2C2, CA

(21) Appl. No.: 09/877,094

(22) Filed: Jun. 11, 2001

Related U.S. Application Data
(60) Provisional application No. 60/225,845, filed on Aug. 11, 2000.

(51) Int. Cl. G06F 17/60

(52) U.S. Cl. 705/26

(57) ABSTRACT

A computer method and system for electronic shopping that, without load or reload of browser pages, allows immediate add or change of item quantity and display of transaction amounts. A vendor can choose to include any number of item order pages, category order pages, or order summary pages that show the associated current item selection upon page load. An optional running subtotal enhances performance while using recorded data ensures reliability. Optional components accelerate and aid in the order process. Detailed and pictorial item information, if included, can be displayed throughout. Advertisement can be presented in intermediate referring pages used for updates, and in a mouse-over preview window when it is not being used for selection and verification. Web site vendors can obtain an accurate picture of user behavior and interests. The system can be implemented on a network, off-line using a portable medium, or obtaining partial information from a network.

### BACKGROUND OF THE INVENTION

Field of the Invention

The present invention relates to a computer method and system that uses a web browser for electronic shopping in which items are quickly located, selected, and verified.

| | |
|---|---|
| Current US Classes: | 705/27 |
| Intern'l Class: | G06F 017/60 |

References Cited
U.S. Pat. Documents

| | | | |
|---|---|---|---|
| 5,715,314 | Feb. 3, 1998 | Payne, et al. | 705/78 |
| 5,745,681 | Apr. 28, 1998 | Levine, et al. | 709/200 |
| 5,774,670 | June 30, 1998 | Montulli | 709/227 |
| 5,826,242 | Oct. 20, 1998 | Montulli | 705/27 |
| 5,890,175 | Mar. 30, 1999 | Wong, et al. | 705/505 |
| 5,905,973 | May 18, 1999 | Yonezawa, et al. | 705/27 |
| 5,956,709 | Sept. 21, 1999 | Xue | 707/3 |
| 6,032,130 | Feb. 29, 2000 | Alloul, et al. | 705/27 |
| 6,058,373 | May 2, 2000 | Blinn, et al. | 705/26 |
| 6,061,057 | May 9, 2000 | Knowlton, et al. | 345/335 705/26 |
| 6,101,482 | Aug. 8, 2000 | DiAngelo, et al. | 705/26 |

Foreign References

| | | |
|---|---|---|
| 98/21679 | May, 1998 | WO |
| 99/57864 | Nov, 1999 | WO |
| 99/67700 | Dec., 1999 | WO |
| 00/41520 | July, 2000 | WO |
| 00/43850 | July, 2000 | WO |
| 1024448 | Aug., 2000 | EP |

### OTHER REFERENCES

HTML 4.01 Specification W3C Recommendation Dec. 24, 1999 on-line at: http://www.w3.org/TR/html40

JavaScript Documentation, Copyright® 1999 Netscape Communications Corporation on-line at: http://developer.netscape.com/docs/manuals/javascript.html

Netscape Object Signing: Establishing Trust for Downloaded Software, Last updated Jul. 2, 1997. on-line at: http:/Hdeveloper.netscape.com/docs/manuals/signedobj/trust/index.htm

RAGGETT, DAVE AND ARNAUD LE HORS; HTML 4.0, Last Modified: Monday, Nov. 17, 1997 on-line at: http://webtools.ecu.edu/html/history/html40.htm

SELIGMAN, LEN AND ROSENTHAL, ARNON The Impact of XML on Databases and Data Sharing, Published March 2000 on-line at: http://www.mitre.org/support/papers/tech_papers99_{—}00/seligman impact/index.shtml

WILSON, BRIAN; Browser Time Lines, Last Modified: Monday, Nov. 17, 1997, on-line at: http://webtools.ecu.edu/html/history.htm

During recent years the Internet, particularly the World Wide Web (the “Web”) and other similar networks, have become a venue for electronic commerce for consumers, businesses and governments. The shopping cart/bag/basket has become the standard method where a purchaser can ADD to the cart, VIEW the cart, EMPTY the cart, DELETE an item, or change the quantity of an item by updating the cart and is analogous to conventional shopping.

The shopping cart's origin stems from the constraint that early web browsers could only display Hypertext Markup Language (HTML) and lacked other functionality. To conduct electronic commerce, items to be purchased were presented in a browser window or frame, and the purchaser was given the option to ADD the item(s) to the shopping cart. Scripts on a server were used to record and track the items added. The summary list or shopping cart was encoded into HTML on the server and transmitted back to the client browser for review. Any change to the shopping carts contents would be transmitted back to the server that would then encode the updated contents and transmit them back in HTML to the client browser.

Today sites still use the shopping cart model and server scripts still track item selections. In many sites the user is automatically directed to the list page or basket for each item added. Some sites have the option to select several items concurrently using check boxes; however, the user is not informed of order amounts with each selection as calculations are only updated when the basket or summary list is displayed or updated. To continue ordering, a select a special link is required that navigates to an intermediate page. This may not be of interest and the user may get lost, failing to remember exactly how to navigate back to items of interest again. Often the vendor's shopping cart is on a secure server and this places additional load on the server and network due to encryption. All this causes delay and leads to purchaser frustration.

Constraints of the client-server environment requiring the use of a single calculating page or shopping cart has further limitations. Since items to be selected are on different pages than the basket, paging back and forth through multiple pages leads to confusion and mistakes. For example, to add ten items to a shopping cart and be constantly informed of order amounts requires the download of ten item pages and the display of the cart/basket/bag ten times for a total of 20 pages. A minimum of twenty mouse clicks are required to navigate and the ordering process typically takes several minutes to complete. One must remember what the products look like. As the paging takes several minutes, the user may forget what was initially ordered and have to navigate back through several pages to confirm the items. There may be a similar item but there is no way to determine if it is the specific item that was previously selected. To correct resultant mistakes, or change quantity, the basket must be loaded, the entry changed, and the basket page reloaded. This process is confusing, time consuming and frustrating, thus, limiting the number of items that can be effectively ordered.

Over time, more functionality was added to web browsers and it was realized that network traffic and server load could be reduced by implementing the shopping cart on the client side. Instead of using a server, the client computer tracks selected items and when completed, the order is sent to the server for purchase. Although faster than the server side implementation of the shopping cart, there is only one calculating page. Users must page or scroll back and forth to add items to the shopping cart. The page loads are time consuming and the problem of remembering exactly what has been selected when the cart is not displayed remains.

Consequently, many people who access the web will not shop on-line and many shopping carts are simply abandoned. Impulse buying is curtailed. On-line vendors, if profitable, are not as profitable as they could be. Vendor servers are tied up by the paging required to operate shopping carts. Businesses, governments and consumers using the web for procurement of goods and services, are spending more time than necessary and therefore have lower productivity.

In mid 1997, Netscape Communications Corporation and Microsoft Corporation released browsers supporting elements HTML 4 as endorsed by the World Wide Web Consortium (W3C http://www.w3.org). These combined improvements in scripting languages, such as VBScript®, Javascript® and Tcl, enhanced the functionality of browsers. Yet, the industry continues to use the shopping cart model derived from the constraints of a simple browser without scripting in a client server environment.

Another factor slowing down ordering is that Web browsers support a limited number of form elements. There is a Selection Drop Down Box that can present a limited number of pre-defined choices. There is a Text Box element in which the user can enter multiple item quantity but this must be done using the keyboard, and the value when entered becomes text value. This results from the markup languages (i.e., SGML, HTML, . . . ) being initially specified for markup of text documents and the functionality for numerical calculations was added later through scripting. Wheel Boxes, which increment and decrement numerical values using a mouse, are well known mechanisms used in graphical operating systems since the early 1980's. However; to date, the industry has failed to include this functionality for Web pages.

### BRIEF SUMMARY OF THE INVENTION

The present invention is a system and method of electronic shopping using a web browser that allows selection of or change of item quantity in-place without having to load or reload pages or frames. The time required to order; the vendor server load and network transmission costs are all reduced. The system consists of any number of order pages and at least one order summary page to complete a transaction. The invention can be embodied on a computer, on a computer network, on a portable medium for a computer or a combination thereof.

Each item selection or change in item quantity, made without browser document load or reload, is recorded and any order transaction amounts specified by the vendor are displayed. The invention can be displayed in one browser window with frames or in multiple browser windows. Access is provided to navigate to every page in the system at any time. Upon order page load, previously selected items applicable to the page are recalled from the recorded data and displayed, eliminating the need to remember what was previously selected. Upon an order summary page load, all previously selected items are recalled from the recorded data.

Any item quantity can be adjusted in-place and the change of item selection is always recorded. Consequently, loading a category order page, item description order page, or an order summary page always displays the current item selection applicable to that page. In other words, changes for an item made on one page will be reflected on load of any other page displaying that item.

According to a preferred embodiment, used for illustration of the best mode of the invention, a web browser frameset presents order pages, order summary pages, navigation and other informational pages in a lower frame. The upper frame displays; navigation hyperlinks to pages in the lower frame, various user instructions; and specified transaction amounts. A vendor can choose to include any number of customized; category order pages, item description order pages, and order summary pages. Category order pages, having two or more items to be selected, can be in list and picture format amongst others. Item description order pages display a single item for selection with detailed information that is available throughout the order process. Order summary pages, displaying all selected items, can be in list and picture format amongst others. The list format order summary page, presented as an invoice, is used to complete a transaction.

List format category order pages are optionally enhanced by: displaying a small preview image of the item in a mouse-over preview window when the mouse pointer passes over the item listing; and by hyperlinking the item's listing is to the item description page allowing immediate access to the detailed information with a mouse click or equivalent. These optional features assist in finding, selecting and confirming items to be ordered. Optionally, list format category order pages are further enhanced by including a pictorial summary of previously selected items upon page load. The pictorial summary is updated by an intermediate referring page that can be used to display advertisements. The mouse-over preview window when not being used to find, select, or confirm items also can be used for advertisements.

Picture format order pages are optionally enhanced by including an element hyperlinked to an item's description page allowing immediate access to the detailed information. If an image is used for the hyperlinked element, it is possible to present item status information using a rollover image that provides discount or any other relevant information.

To quickly locate items, site navigation pages and/or a search engine can be included. The advantage of using the search engine is that, upon display of the search results, multiple selections of varying quantities can be made for items, without having to load or reload pages.

Item selection is accelerated if a quantity adjustment component is included, enabling the selection of, or deletion of, multiple items without having to use the keyboard. Using this component, multiple item selections can be made in less than one second per item. The quantity adjustment component for Web pages has practical utility in other e-commerce applications.

According to one aspect of the present invention, specified transaction amounts can be calculated from the recorded data. For order summary pages, all selected items are recalled during page generation. For an order page, all selected items for the entire order may not be displayed and must be recalled separately to calculate specified transaction amounts.

According to another aspect of the present invention, the use an optional running subtotal for order pages enhances performance. If the running subtotal is used, its value is recorded and recalled upon order page load.

According to another aspect of the present invention, the specified transaction amounts are updated and item selection is recorded immediately upon selection or change of item quantity. This insures functionality for both Netscape Navigator® and Microsoft Internet Explorer® browsers. However, it is possible to delay the update transaction amounts and the recording item selection until all item selections and changes of item quantity have been completed thus reducing the load on the client computer.

According to another aspect of the present invention, cookies, small text files written to disk, are used for recording of selected item data and can be made persistent across multiple order sessions for recurrent orders. Cookies can be recorded in any format suited to vendors needs.

According to another aspect of the present invention, occasional errors by browsers when recording item selection in cookies may lead to errors in the running subtotal calculation. In this event, the running subtotal is corrected by instructing the user to load a page with the order subtotal procedure that uses the recorded data for the calculation of specified transaction amounts.

According to another aspect of the present invention, zero price assigned to items will retain item selection for price quotations.

According to another embodiment, for large orders exceeding limits placed on browser capacity, minimal data is recorded by the client and transmitted to the vendor's server which returns the complete item specification to the client to generate order summary pages.

According to yet another embodiment of the invention, memory is used for recording item selection data allowing orders on disk-less workstations or when the browser cookie function is disabled.

According to another preferred embodiment, the invention is distributed in whole or in part to the customer on a portable computer readable medium. This enables a vendor to distribute extensive detailed item information saving network transmission costs and delays for network download are eliminated. If all information is included on the portable medium, it is possible to order off-line. Alternatively, information subject to change, such as price, can be maintained on the vendor's server with the remaining information being distributed on the portable medium. Thus, the vendor need only update the server to effect price changes.

According to yet another preferred embodiment, along with recording item selection, the time of item selection is recorded. For marketing statistical analysis, correlation of the time taken to select items with user viewing times derived from the server logs for page download directly reflects user preferences due to the elimination of multiple paging during the item selection process.

This summary of the invention and the following detailed description should not restrict the scope of the claimed invention. Both provide examples and explanations to enable others to practice the invention. Many other beneficial results can be attained by applying the disclosed invention in a different manner or modifying the invention as will be described. The accompanying drawings, which form part of the description for carrying out a best mode of the invention, show several embodiments of the invention, and together with the description, explain the principles of the invention.

### BRIEF DESCRIPTION OF THE DRAWINGS

The invention will be better understood by way of the following detailed description with reference to the appended drawings, in which:

FIG. 1 is an opening frame set of a preferred embodiment.

FIGS. 2A-2D illustrate the list and picture format category order pages with the associated repeated HTML code used to dynamically generate the item displays.

FIGS. 3A-3B illustrate an item description page displayed in a pop-up window and in the lower frame.

FIGS. 4A -4C illustrate example order summary pages: an invoice page; the repeated HTML code used to dynamically generate item listing; and an order picture summary.

FIGS. 5A-5F illustrate some of the possible variations for the category order pages and the repeated HTML code used for item display.

FIGS. 6A-6B illustrate a simple keyword search engine.

FIG. 7 shows performance data for the order system.

FIGS. 8A-8C illustrate input data structures, a conceptual diagram and a schematic block of diagram of a representative system.

FIGS. 9A-9F illustrate: the quantity adjustment component; a simplified block flow diagram of the running subtotal procedure for order pages; a simplified block flow diagram of the order subtotal procedure for order summary pages; a simplified block flow diagram of the order subtotal procedure for order pages and deferred calculation procedures.

FIGS. 10A-10D are simplified block flow diagrams of the routines that generate category order pages, recall selected items, save selected items and calculate the order subtotal from recorded data.

FIGS. 11A-11C are simplified block flow diagrams of the routines that generate an item description page, recall a selected item, and save a selected item.

FIGS. 12A-12C are simplified block flow diagrams of the routines that generate order summary pages, recall selected items, and save selected items.

FIG. 13 is a simplified block flow diagram of an example routine for using memory to store item selection.

### DETAILED DESCRIPTION OF THE INVENTION

In the following description, numerous specific details are set forth in order to provide a more thorough understanding of the present invention. It will be apparent, however, to one skilled in the art, that the present invention may be practiced without these specific details. In other instances, well-known features have not been described in detail in order not to unnecessarily obscure the present invention. Due to the flexibility of the present invention and Web Browsers, it is only possible to present a limited number of examples expressing the current invention. One skilled in the art will realize that the invention can be expressed in other fashions.

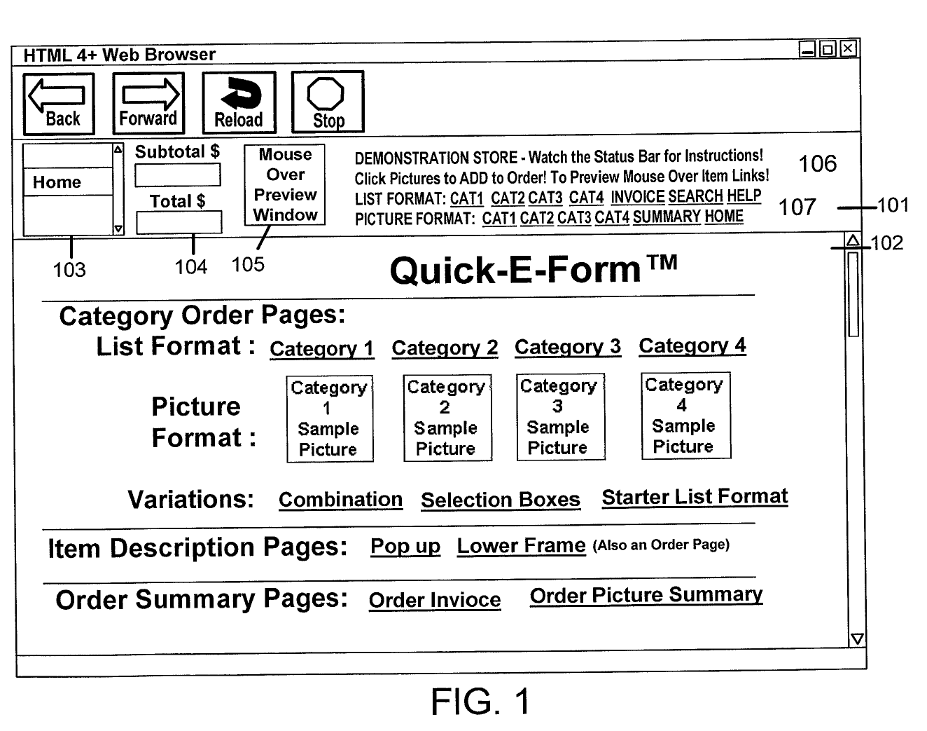

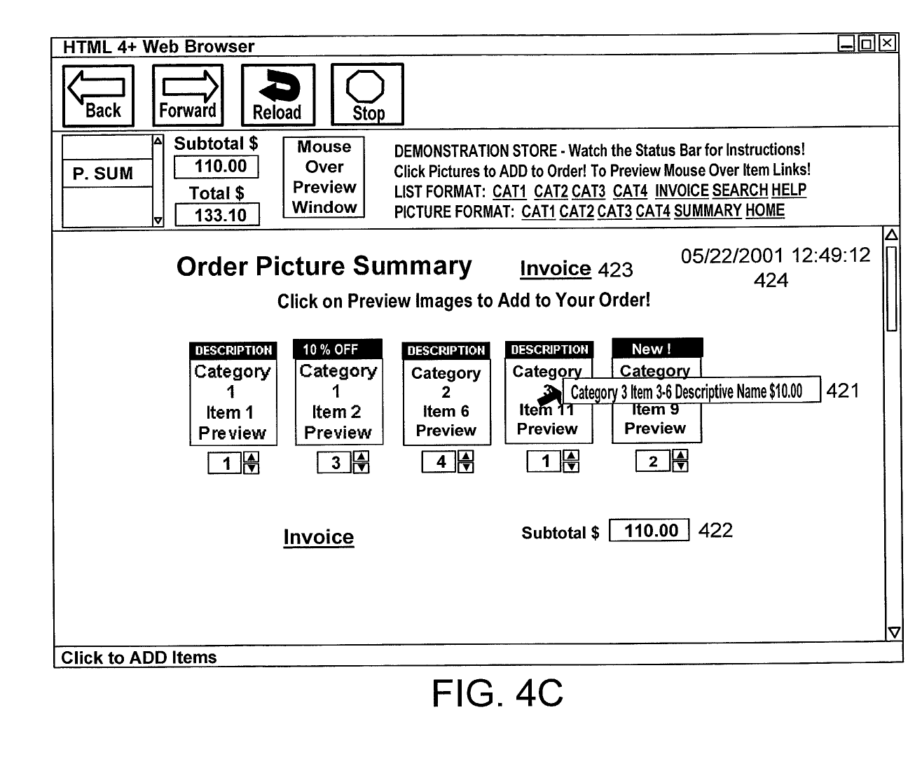

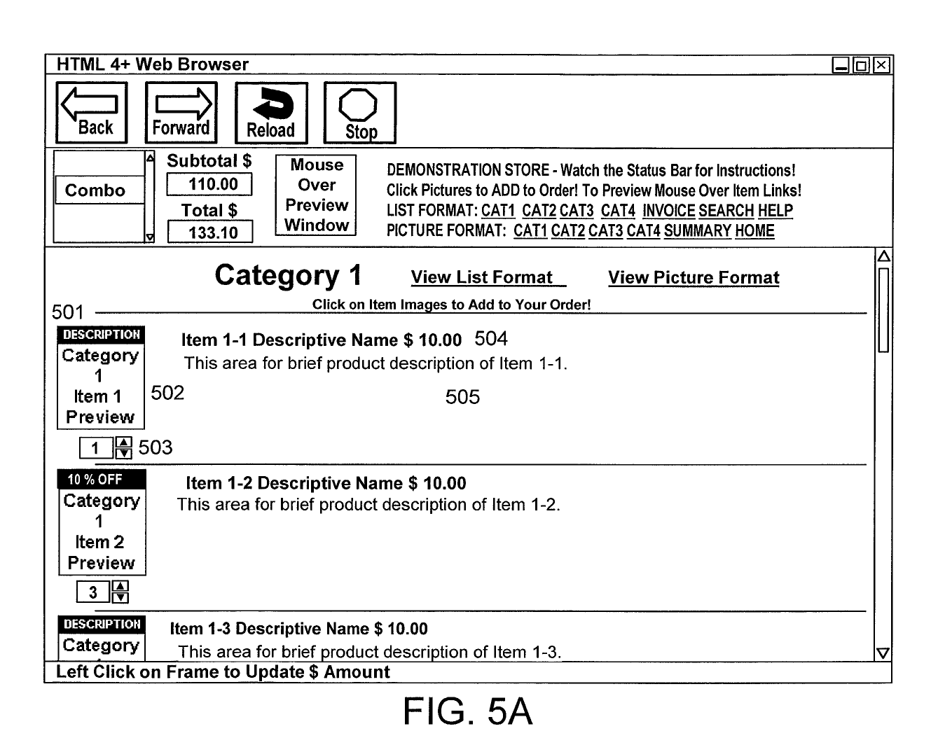

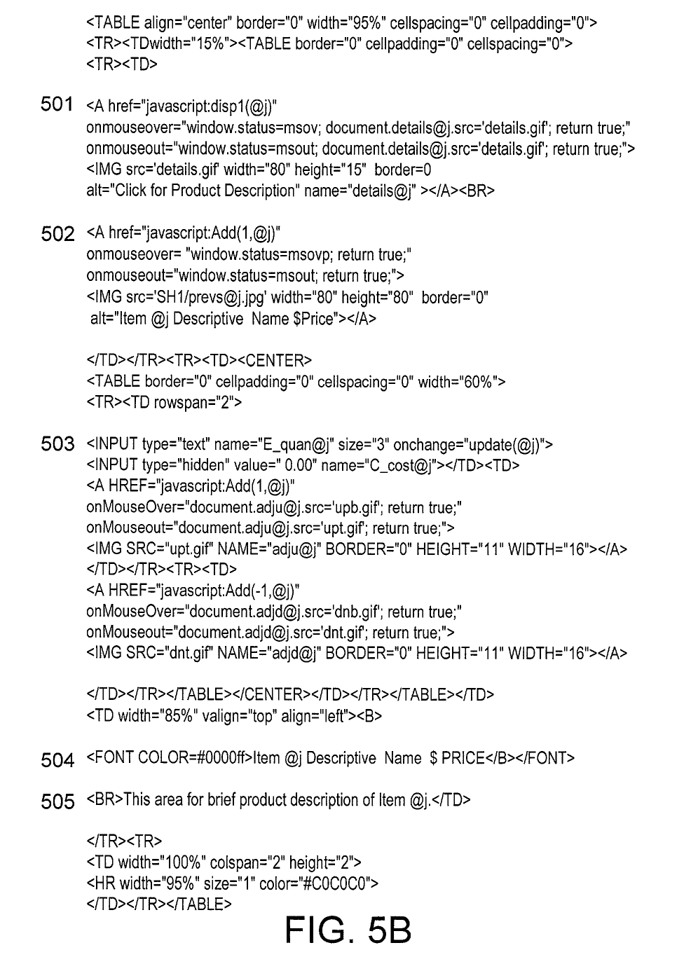

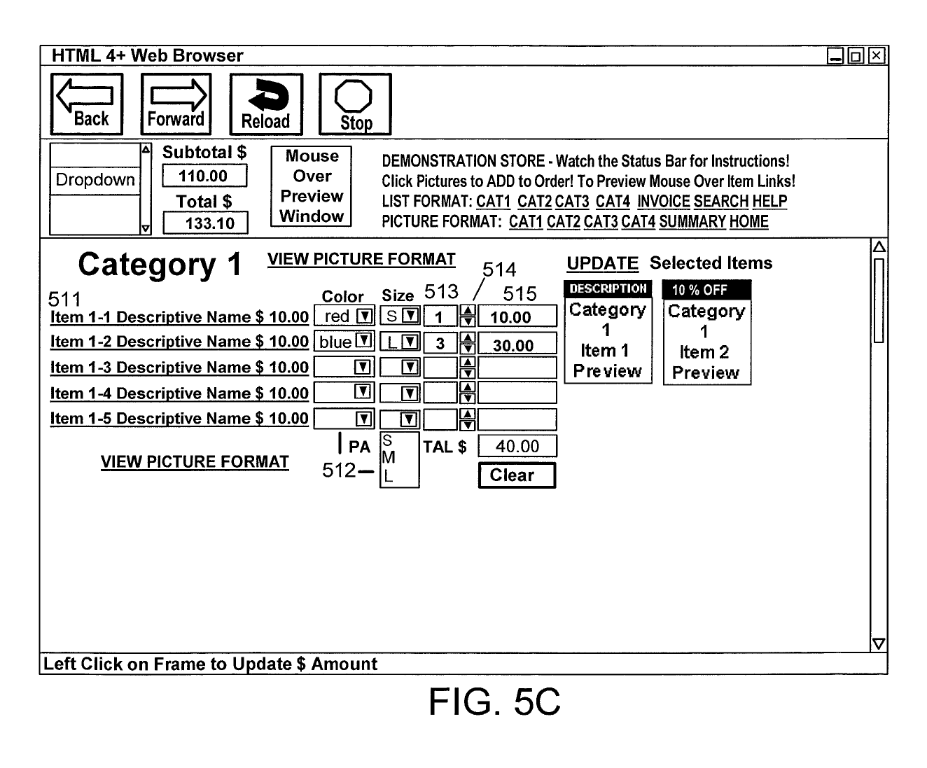

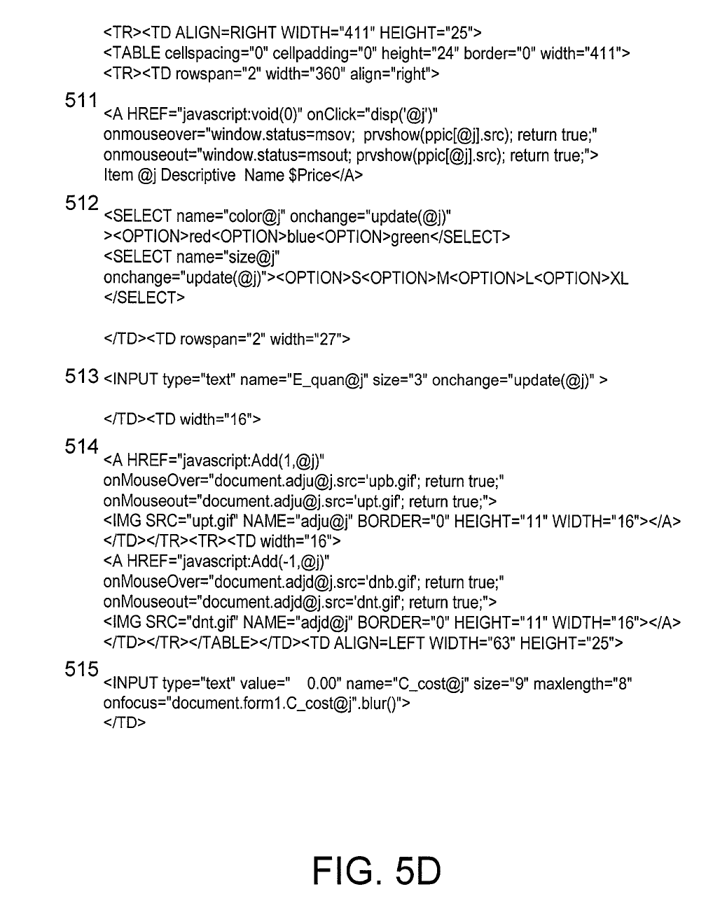

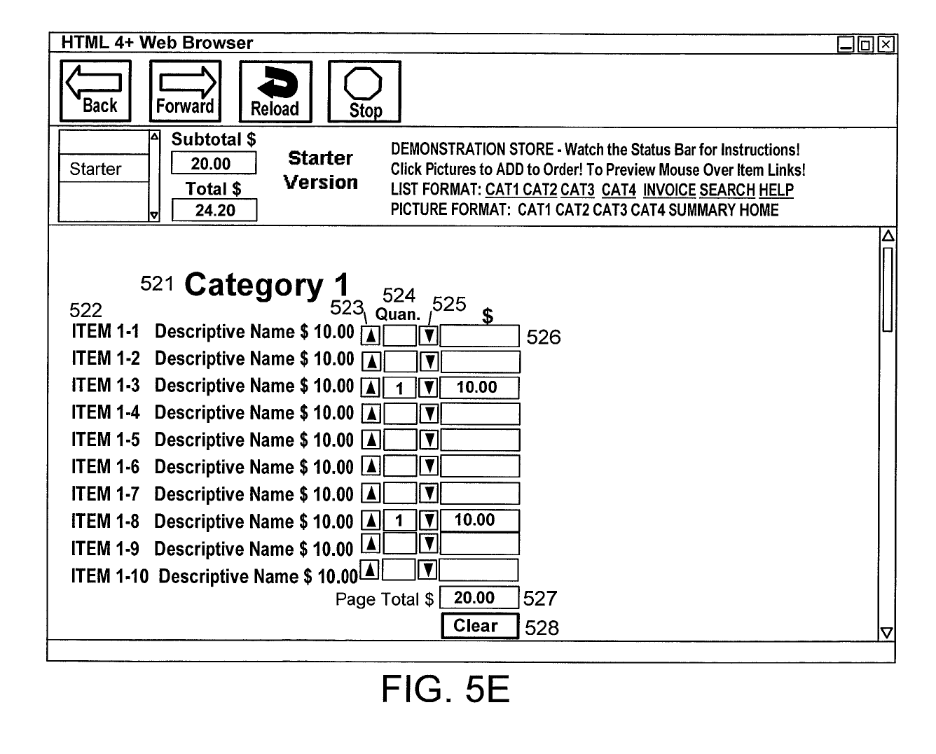

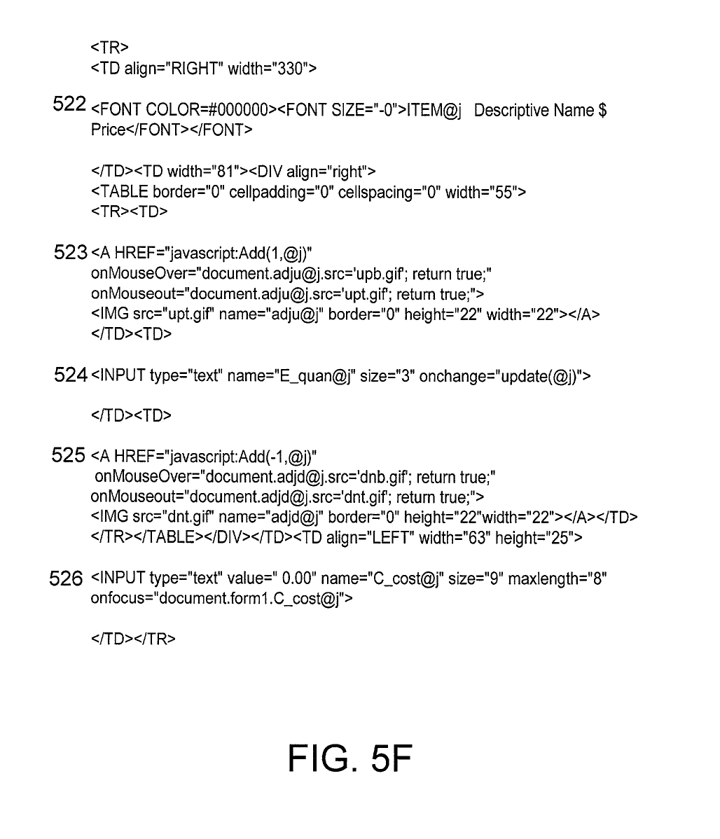

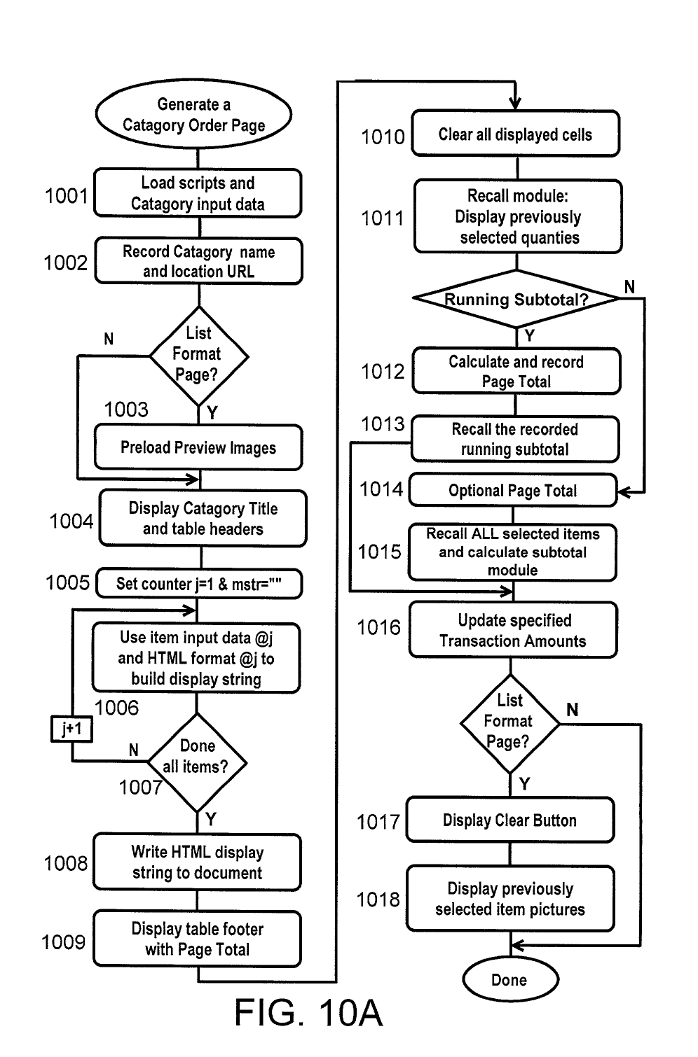

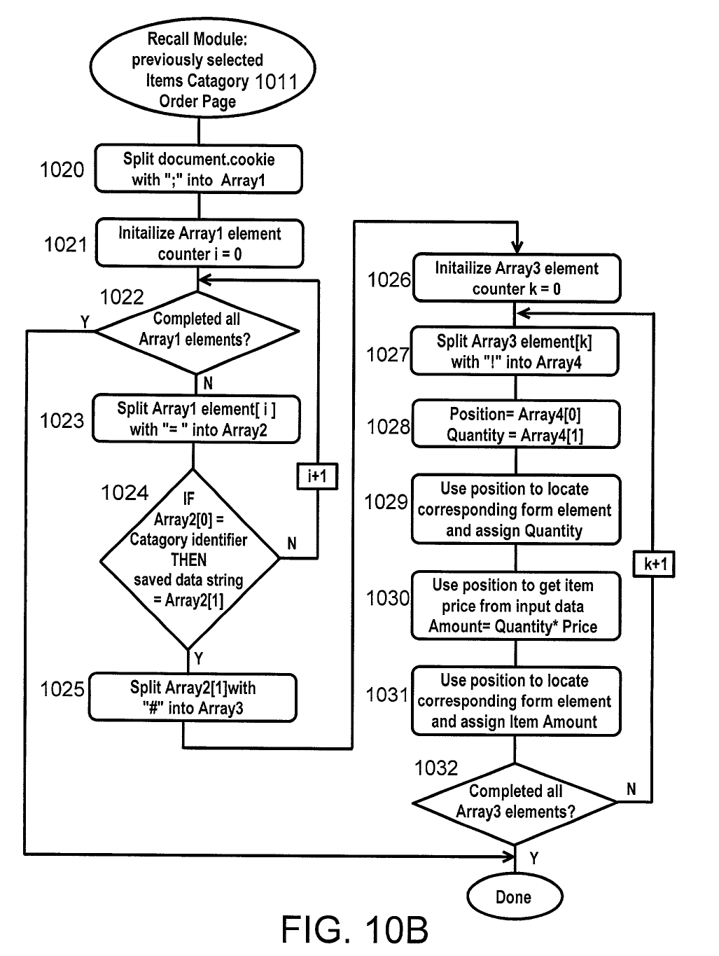

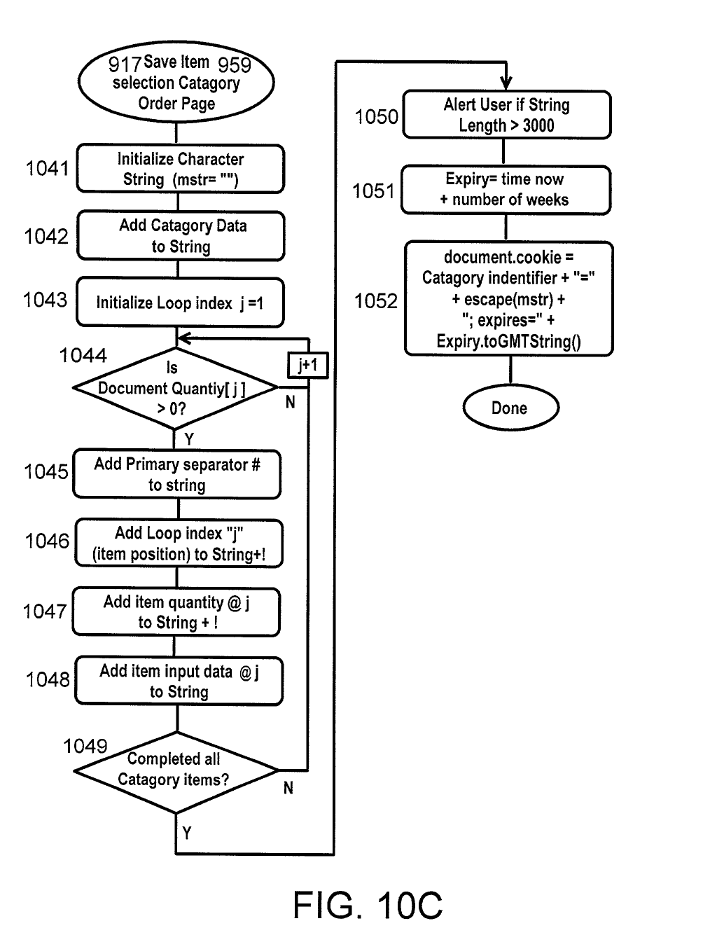

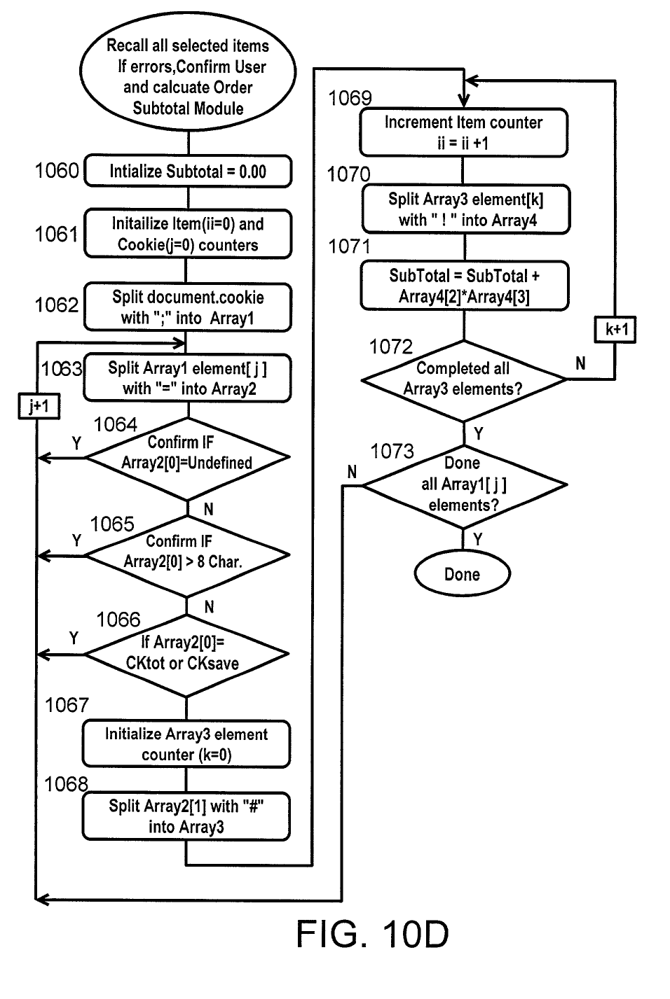

One preferred embodiment, used for illustration of the best mode of the invention, has list format and picture format category order pages and is presented in FIGS. 1-4C. The corresponding page generation, recall of selected items, and save of selected items are presented in FIGS. 10A-12C. Some of the possible variations for category order pages are illustrated in FIGS. 5A-5F. Remaining drawings and description further explain the present invention and illustrate some of the other embodiments. A small Glossary is included at the end of this section to define selected terms.

Key features illustrated by this embodiment are as follows: items can be selected or changed in quantity without the time delay of load or reload of pages; the transaction amounts are updated with each change in selection or amount; hyperlinks allow navigation to any order page or order summary page at any time and previously selected item quantities are recalled and displayed upon page load.

FIG. 1 illustrates an opening frame set of a preferred embodiment with an upper 101 and lower 102 frame. The upper frame presents a single common reference area to recognize and access the entire system. The upper frame is comprised of: a drop down navigational box 103, transaction amounts 104, a mouse-over preview window 105, various user instructions 106, navigational links 107 and various hidden values required for system operation. The lower frame is an example of a site navigation page containing links to various item categories and major components of the system. As this site navigation page is in the opening frame set, it also contains a check and a redirect to an alternate page for non-compliant browser versions.

One skilled in the art would realize that: a different number of categories may be required; additional transaction amounts may be displayed; a greater number of frames, different styles of navigational links and additional site navigation pages can be used. Furthermore, one skilled in the art also would realize that a frame set is not required, as common data is accessible from separate browser windows. As one example, the transaction amounts and mouse-over preview window could be displayed in a small pop up window.

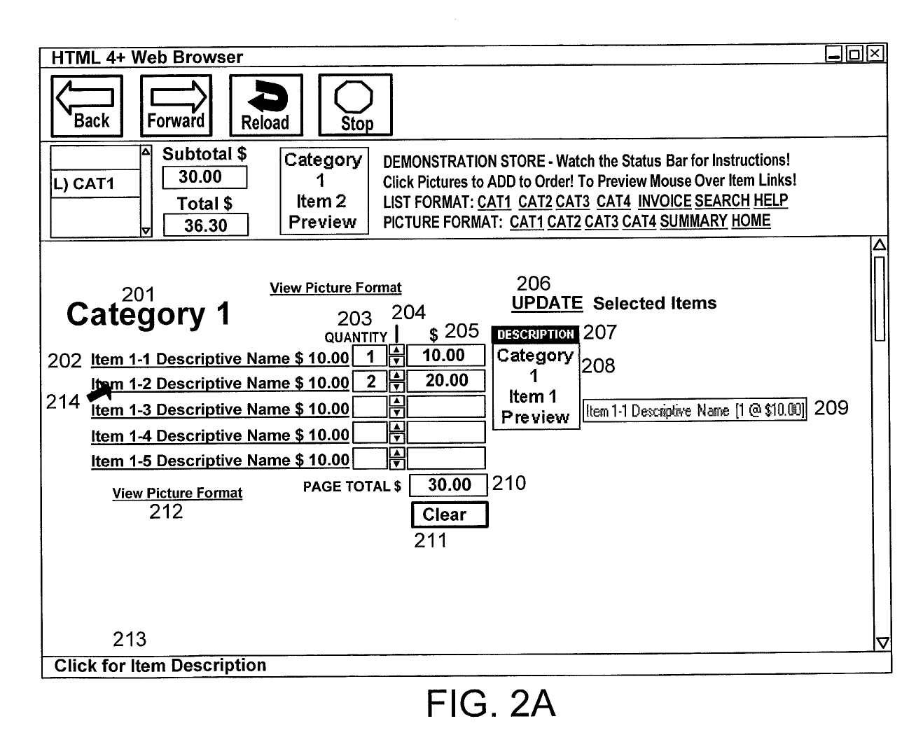

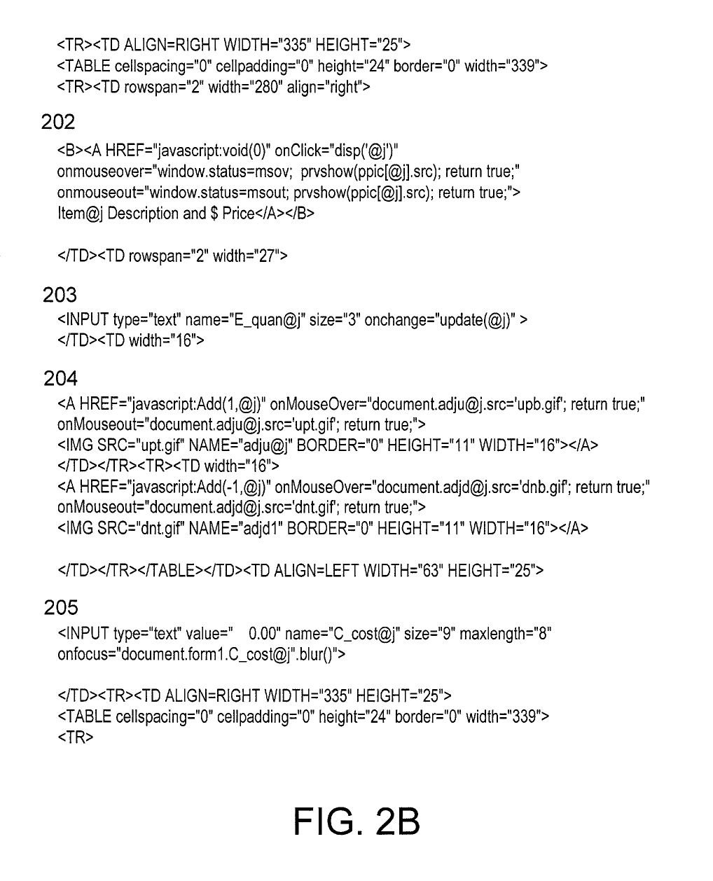

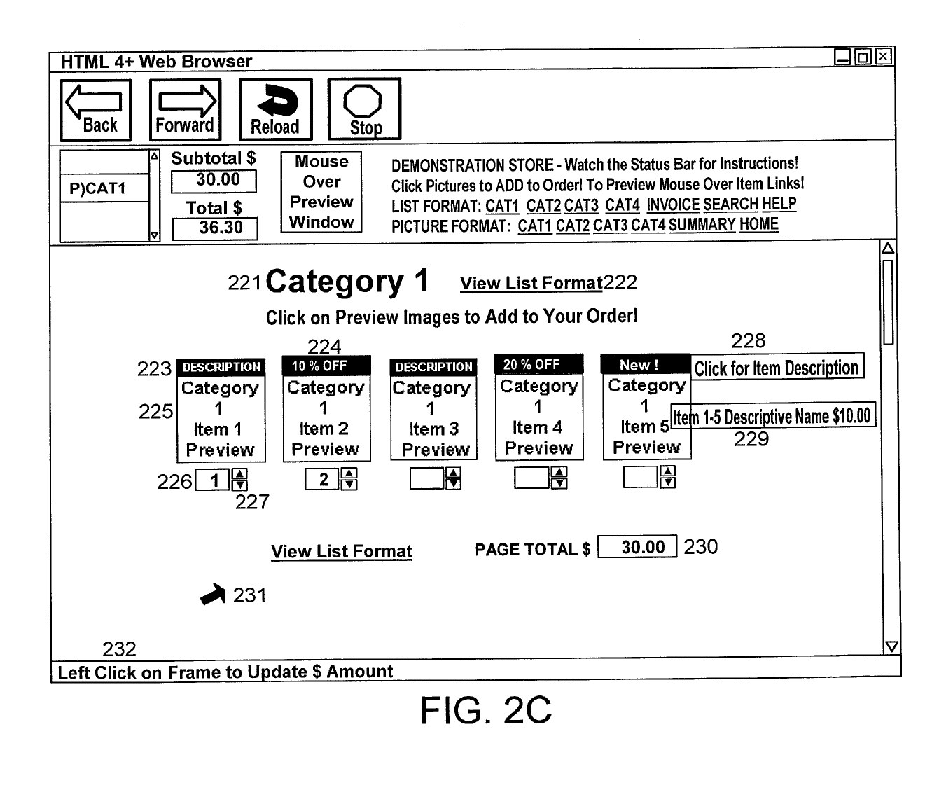

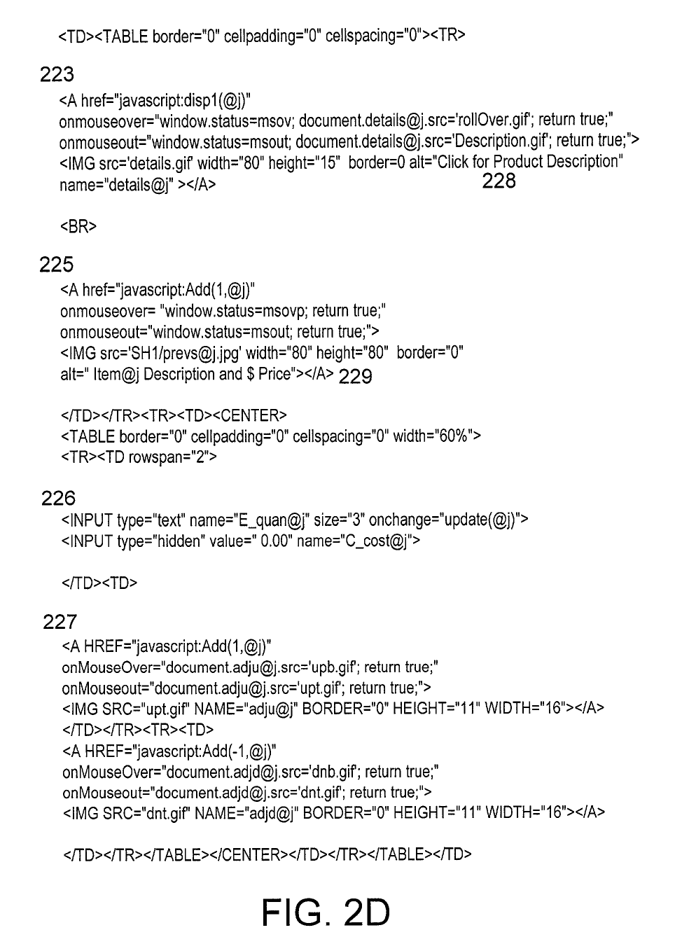

FIGS. 2A-2D illustrate the list and picture format category order pages with their associated repeated HTML code segments that are used to dynamically generate the item displays. Detailed discussion of the drawings follows:

FIGS. 2A illustrates a list format category order page in the lower frame. It is comprised of: category title 201; descriptive item name hyperlinks 202; text boxes for quantity specification 203; quantity adjustment buttons 204; text boxes 205 for item amounts; a hyperlink 206 for an optional updated display of selected items in a modified picture format; a hyperlinked image 207 for display of the item description page; selected item preview picture(s)208; an informational pop-up tag 209 showing the descriptive item name, quantity, and price; a text box 210 displaying the page total for the selected items; a button 211 to clear all selected entries and reload the page; a repeated hyperlink 212 to display the same category items in picture format and a browser status bar 213 for user instructions.

The mouse pointer 214 is over Item 1-2 descriptive hyperlink and the corresponding small item preview image is displayed in the mouse-over preview window 105 in the upper frame. Simultaneously, the status bar message 213 indicates “Click for item description”. The preview images can be pre-loaded into the browser picture cache so that the mouse-over preview window changes almost instantly when the mouse pointer moves over the description hyperlinks. This enables the user to rapidly locate items of interest. If the descriptive hyperlink is clicked, the corresponding item description page will be displayed. Similarly, clicking the hyperlinked image 207 presents the same item description page. Thus, textual, pictorial, and detailed information for an item are all readily available to the user. Five items were chosen for illustration. However, the actual number of items that can be displayed is dependent on vendor's needs and may be constrained by the client browser type and computer processing power.

To select or adjust item quantities, adjustment buttons 204 corresponding to listed item can be clicked. On click, the item quantity 203 is adjusted, then the item amount 205, the page total 211, and transaction amounts in the upper frame are recalculated and displayed. The option to enter any item quantity using the keyboard and then left click the frame or tab to update the calculations is always available. Consequently, the user can order-in-place, make multiple selections and immediate changes, without having to wait for the load or reload of any pages or frames.

For user convenience, previously selected items of the category are displayed in a modified picture format upon page load. This category picture summary remains unchanged with additional item selection or changes. The category picture summary is updated by clicking on the update hyperlink 206 or any previously displayed preview picture 208. An intermediate referring page, which in turn loads the list format category order page, is used to accomplish the update. As the browser displays the intermediate page during the update, it can be blank, present additional information, or be used for advertising. The browser's refresh or reload button also will update the category picture summary.

Advantages arise from the category picture summary that are not possible in the current art. There is an immediate visual summary for cross reference with the item listing of previously selected items upon page load. This makes it convenient for the user to keep track of multiple selections and changes made from other pages in the system for the category. In addition, the category picture summary can be used in conjunction with the mouse-over preview window to change category item selection in a visual manor. Updating produces a new category picture summary with the selected item preview images displayed in proximity for further consideration. The preview image pop-up tags further assist in selection, by presenting the item description, quantity, and price.

The page contains a number of elements optional to the basic functionality of making multiple selections of varying quantity and recording item selection without document load or reload. If there are no preview images, then mouse-over preview window, the category picture summary, and the repeated hyperlinks to the picture format are not required. If there are no detailed item description pages the access hyperlinks are not required. Item quantities can be entered using the keyboard, thus the quantity adjustment component is optional.

Category input data for page is comprised of:

category identifier, title, number of items, and category sub-directory name.

Item data used in table row generation for FIG. 2A is comprised of:

item price, Item page URL, item descriptive name, preview picture, and rollover image.

Each change in item selection is recorded. For the selected items displayed, the corresponding recorded data is:

SH1 !Category 1

#1!1!1 0.00!info001.html!Item 1-1 Descriptive Name!prevs001.jpg!details.gif!

#2!2!10.00!info002.html!Item 1-2 Descriptive Name !prevs002.ip!10offgif!

The “#” is used as a primary separator and the “!” is used as a secondary separator. These separators are used in routines to recover the selected item recorded data. The top row is the recorded category data consisting of category identifier and category title delimited with a secondary separator. “SH1”. The category identifier was also used for the sub-directory name. The next two rows contain the recorded data for each selected item delimited by the secondary separator. For each selected item, the item position and selected quantity from the page followed by the item data are recorded. One skilled in the art would realize that recorded data would include information dependent on vendor requirements.

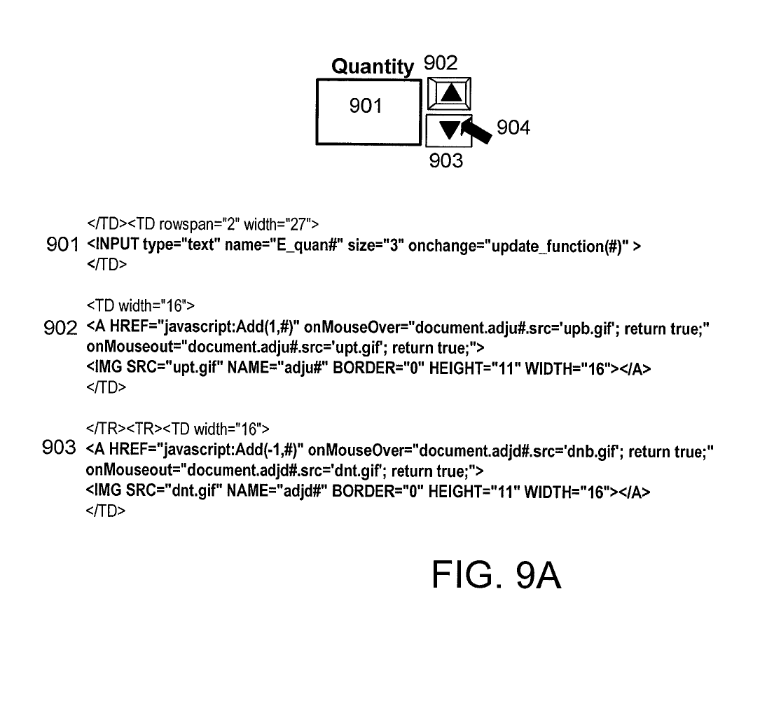

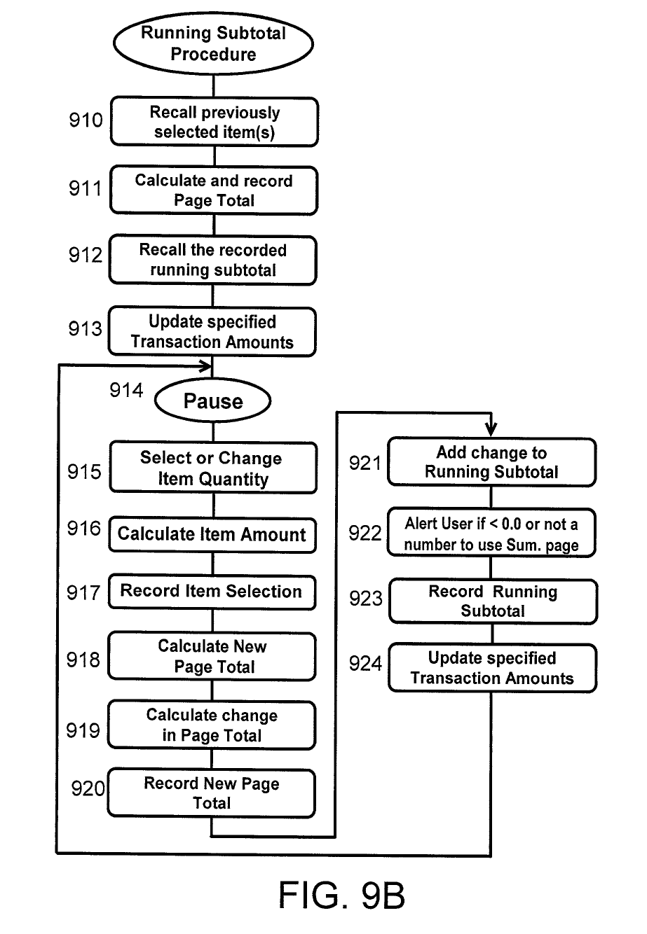

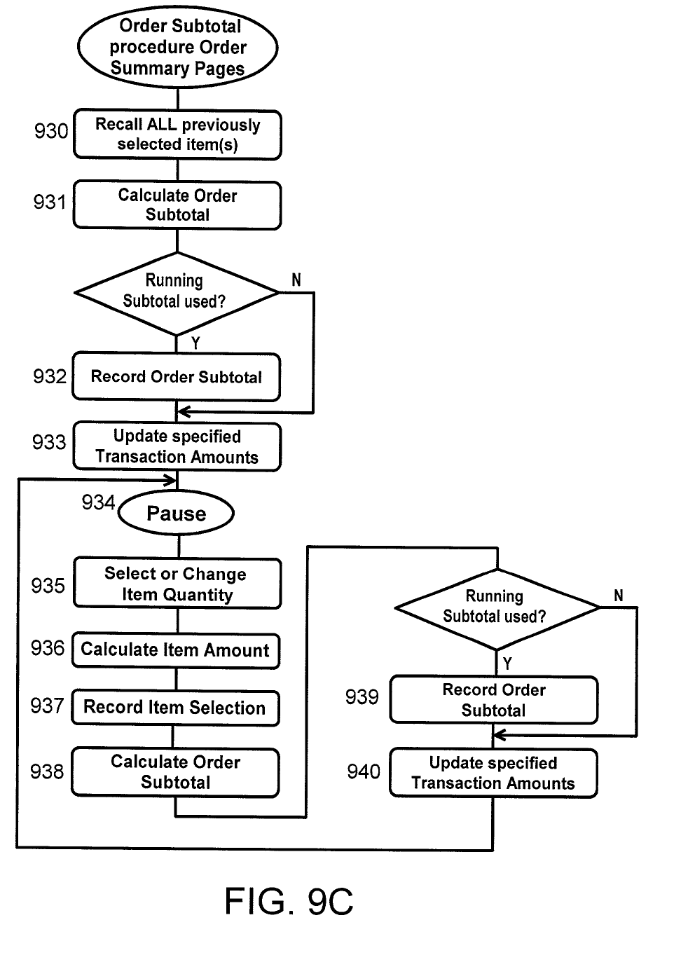

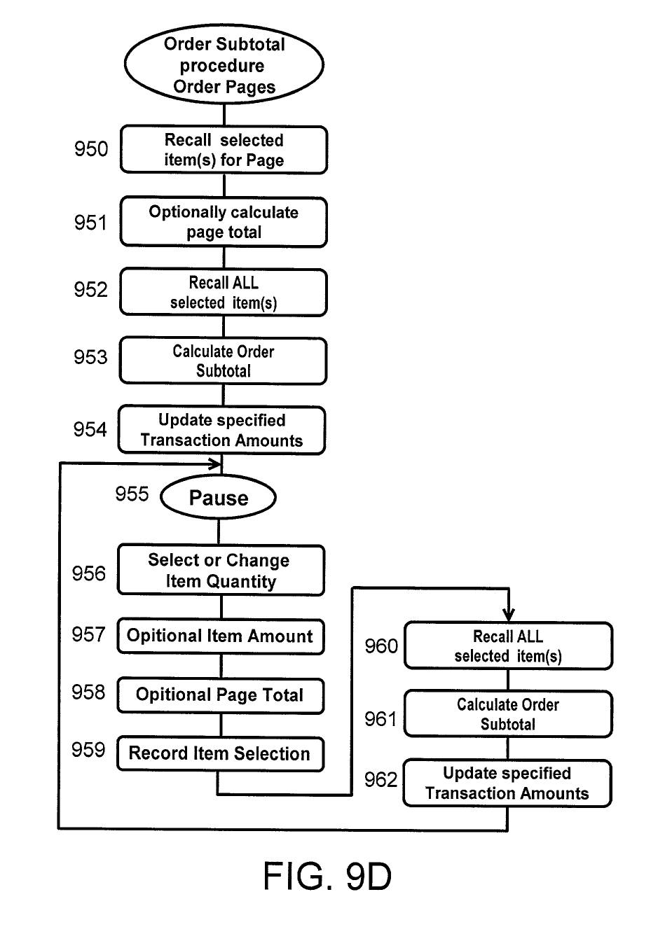

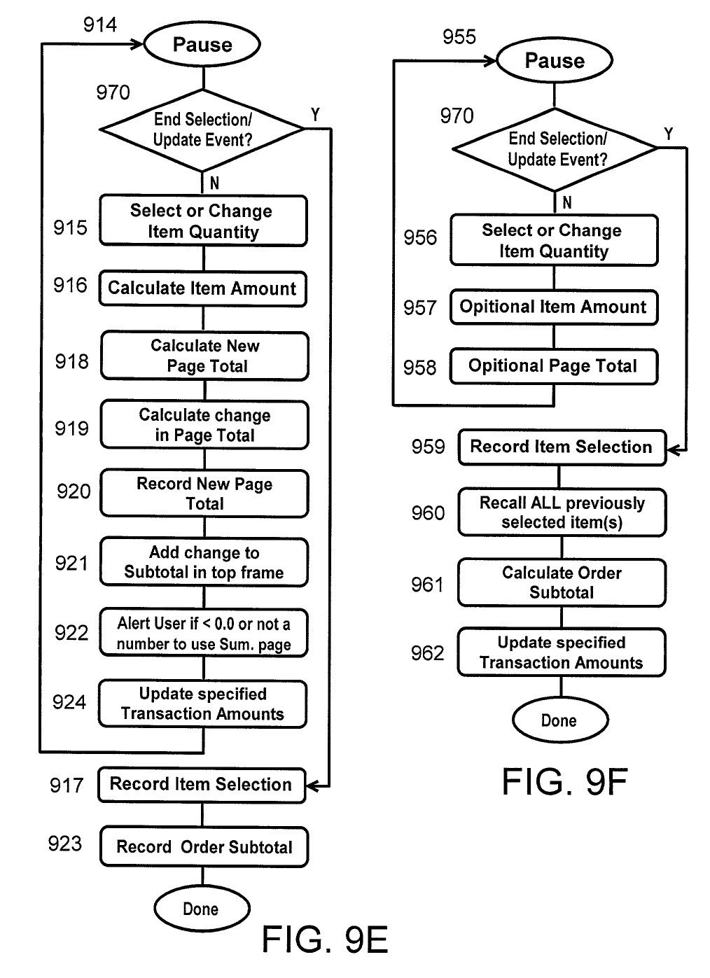

FIG. 2B is the repeated HTML code used to dynamically generate the displayed item table rows of the list format of FIG. 2A. Designed to display properly on both Netscape® and Microsoft® version 4+ browsers, code segments are numbered to correspond with the displayed elements on FIG. 2A. The “@j” symbol in FIG. 2B denotes the item numeric position 1,2,3, . . . and is used similarly in subsequent drawings. In code segment 202: the “JavaScript:void(0)” facilitates a display of the item description page in a pop-up window using the “disp” function; “msov” and “mout” are character strings for browser status bar instructions; and “prvshow” is a function to display the mouse-over preview image. Code segments 203 and 204 constitute the quantity adjustment component discussed in FIG. 9A. The blur method in 205 prevents alteration of calculated values.

FIG. 2C illustrates a picture format category order page in the lower frame. It is comprised of: category title 221; a repeated hyperlink to display the same category in list format 222, hyperlinked rollover images to the item description page 223, informational rollover images 224; item preview pictures 225; text entry boxes for quantity selection 226; quantity adjustment buttons 227; an informational pop-up tag instructing the user 228; an informational pop-up tag showing the descriptive item name, and price 229; a text box displaying the selected items page total 230; the mouse pointer 231 over the lower frame; and a browser status bar user instruction 232. Previously selected item quantities are displayed when the page is loaded.

One skilled in the art would realize that items from a number of different vendors sites could be displayed. The mouse-over preview window is not active and could display additional images for advertising. Additional images can be programmed to display after a predetermined period of inactivity or by mousing over other additional Web page elements.

Clicking on the item preview pictures 225 adds selected items to the order. If the mouse pointer pauses over a preview picture, an informational pop-up tag 229 is displayed showing the descriptive item name, and price. As the preview pictures are large compared to the mouse pointer, the rate of addition to the order depends mainly on the browser type and computer processing power.

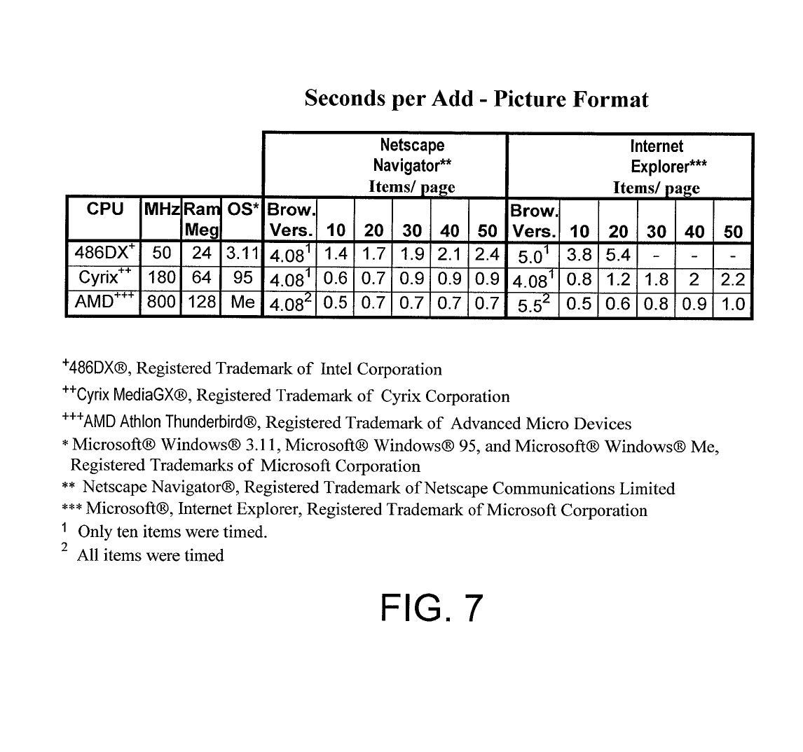

Refer to FIG. 7 for performance data. If an item is inadvertently selected, the quantity can easily be adjusted or the item deleted by clicking on the decrement indicator of the adjustment buttons 227. On click, the item quantity 226 is adjusted and displayed. The item amount is calculated and stored in a hidden text box in the page. The page total 230, and transaction amounts 105 are then recalculated and displayed immediately informing the user of the results for each purchasing decision. Additionally, quantity may be directly entered via text boxes 226 and the calculations updated by left clicking the lower frame or tabbing. As illustrated in the drawing, the mouse pointer 231 causes the browser status bar 232 to display “Left click on frame to update $ Amount”. One skilled in the art would realize that some vendors may prefer to use small pre formatted text instead of an image to increment the quantity.

Detailed information is readily available via the hyperlinked description image 223 that, if clicked, displays the item detail description. It is possible to present special item information such as discount, availability, and so on, by employing rollover images 224 in conjunction with the description images. When the mouse pointer moves over the rollover image, the description image 223 becomes visible. For Item 1 and Item 3 the description image 223 has been used for the roll over image. If the mouse pointer pauses over a description image, an informational pop-up tag 228 instructs the user to click for the item description page. Either image Alt tags or Tool Tips can be used to display the informational pop-up tags.

The page contains a number of elements optional to the basic functionality of making multiple selections of varying quantity and recording item selection without document load or reload. If the vendor chooses not to use the list format, then the repeated hyperlinks to the list format are not required. If there are no detailed item description pages, then the hyperlinked access images and corresponding rollover image are not required. Item quantities can be entered using the keyboard, thus the quantity adjustment component is optional.

FIG. 2D illustrates the repeated HTML code used to dynamically generate the displayed item group for a picture format category order page. Designed to display properly on both Netscape® and Microsoft® version 4+ browsers, code segments are numbered to correspond to the displayed elements on FIG. 2C. The “@j” in FIG. 2D denotes the item numeric position 1,2,3, . . . in a non-visible table with five items per row. In code segment 225 the item preview picture has been hyperlinked to “Add(1,@j)” function and the item amount is specified as a hidden text box value immediately after the quantity text box 226. Each change in item selection is recorded. Since the selected items for the picture format are the same as the list format, the recorded data is identical with that presented above.

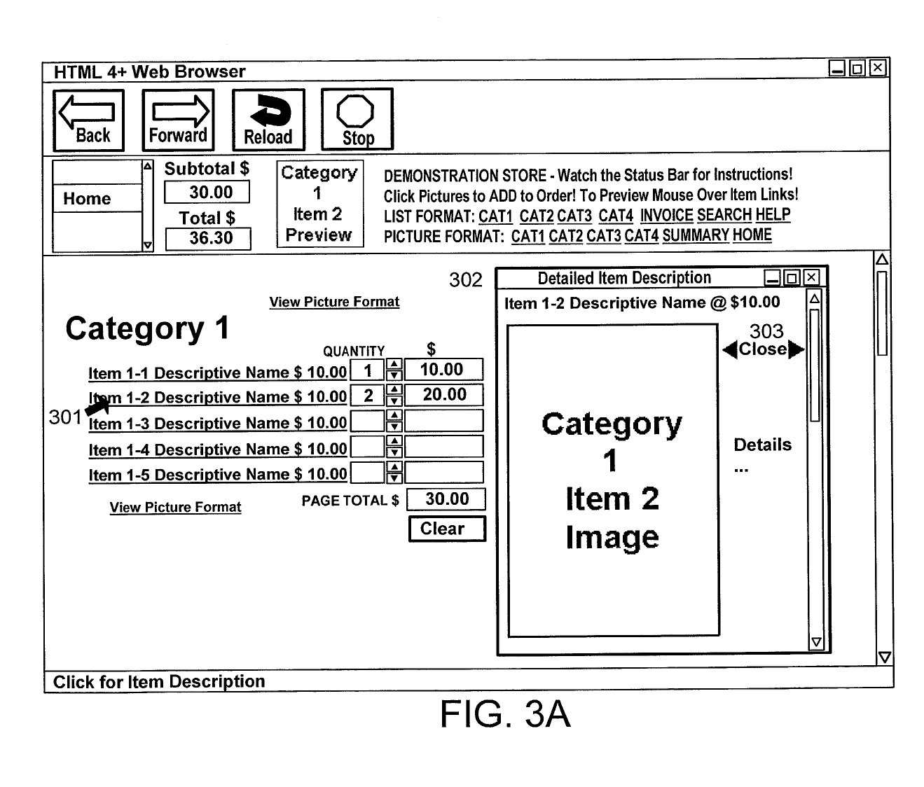

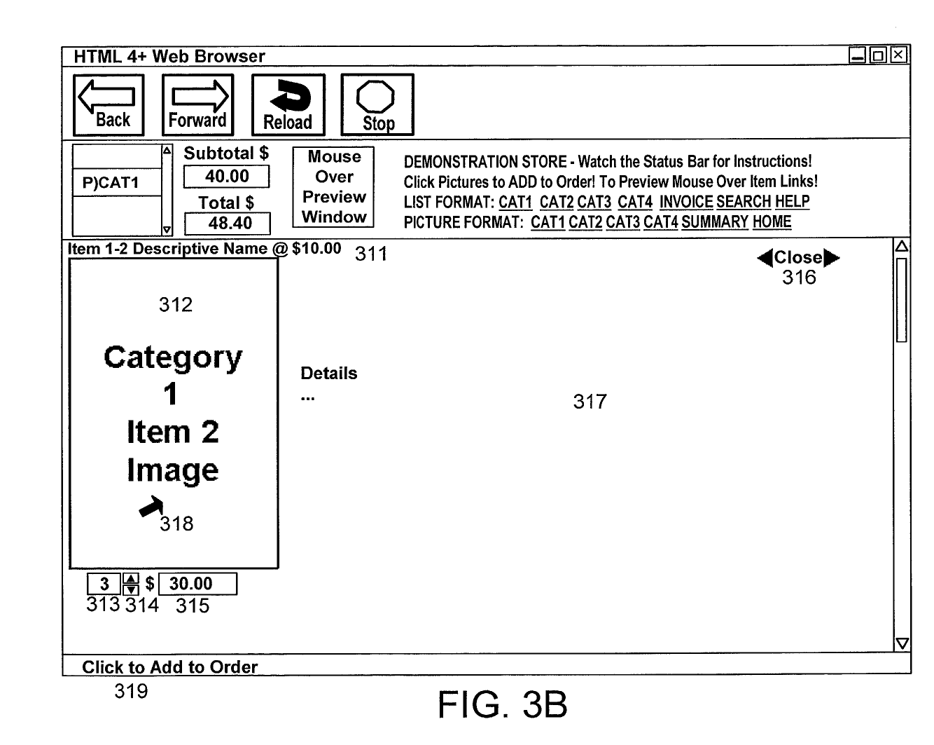

FIGS. 3A-3B illustrate an item description page displayed in a pop-up window and in the lower frame. Both the category order pages and the order summary pages have ready access to the item description page. Thus, detailed item description is always available.

FIG. 3A illustrates an item description page in a pop-up window as the result of clicking an item description hyperlink at the mouse pointer 301. The resultant pop-up window 302 can be re-sized to full screen and presents detailed item information. The pop-up window allows a distributor to link to the manufacturer's description page thus eliminating page setup cost and download charges. The pop-up window is a separate browser window and it has a history allowing the user to easily compare detailed item descriptions using the navigation buttons 303. The order page remains available for resultant item selection during review of the detailed item descriptions. One skilled in the art, will recognize that the item description hyperlinks also could refer to a number of other file types, such as video, sound, or any format type supported by the browser, and not necessarily display a pop-up window.

FIG. 3B illustrates an item description page in the lower frame reached by clicking the description tag 224 in FIG. 2C. This is the same item description page shown in the pop up window of FIG. 3A but includes the quantity adjustment component and, therefore, it is also an order page. It is comprised of: item description text with price 311; a large item picture 312 that is hyperlinked to add to the order; a text box for item quantity 313; quantity adjustment buttons 314; a text box for item amount 315; navigation buttons 316; and the remaining area 317 for detailed item information. Situated in the lower frame, only the back indicator of the navigation buttons 316 is functional. The mouse pointer 318 is over the picture and the browser status bar 319 instructs the user to “Click to Add to Order”. Clicking on the item picture 312, using the quantity adjustment buttons 314, or entering the quantity directly into the text box 313 with clicking on the frame will add to the order. The item amount 315 and the transaction amounts are recalculated and displayed. One skilled in the art would realize that facility to add to order also could be included in the pop-up window.

In addition to category and item data, the item's category numeric page position “@j” must be specified in the input data for an item description page. The item quantity in the FIG. 3B is three and the corresponding recorded data is:

SH1 !Category 1

#1!1!10.00!info001.html!Item 1-1 Descriptive Name!prevs001. jpg!details.gif!

#2!3!10.00!info002.html!Item 1-2 Descriptive Name!prevs002.ipg!10ffgit!

One skilled in the art will realize that a vendor may not have the descriptions or images for all order pages presented, or may not require the use of all order pages presented. Furthermore, the list and picture formats may not suit the vendor's needs. See FIGS. 5A-5E. Accordingly, a vendor may choose to include any number of order pages customized to the vendor's needs.

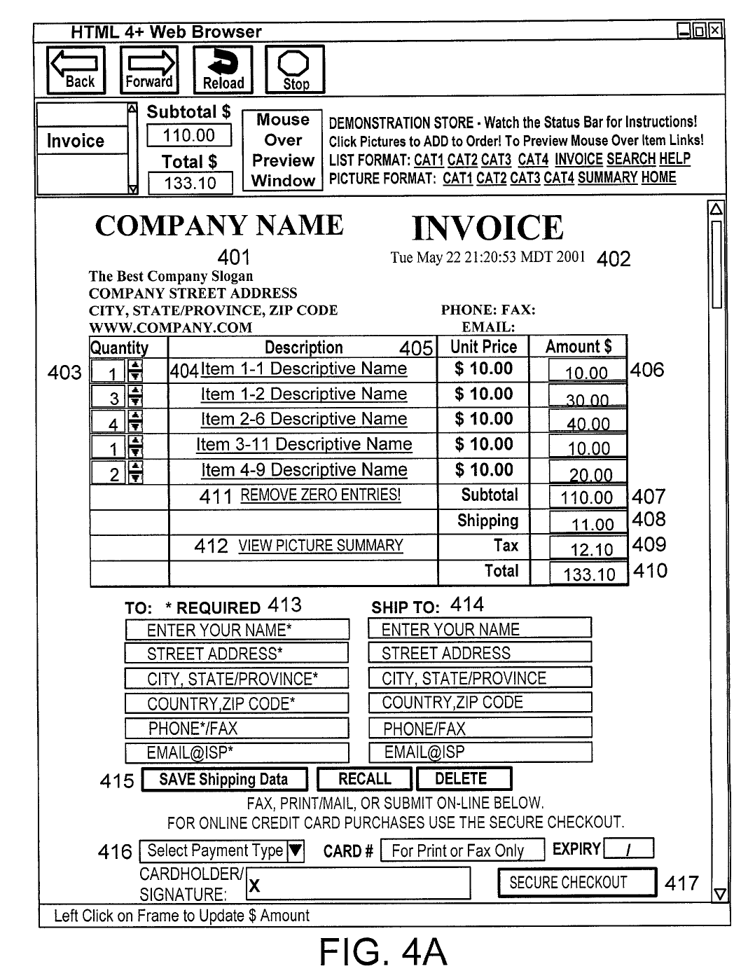

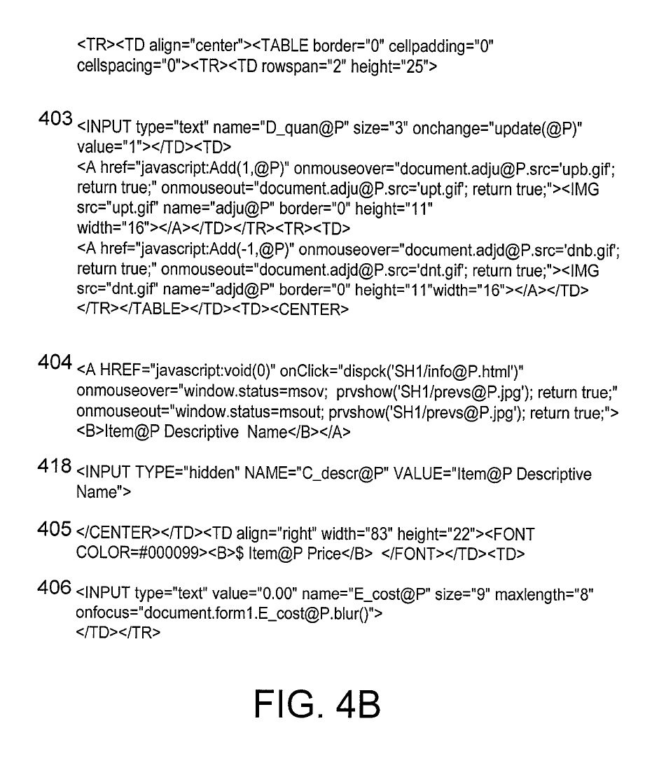

FIGS. 4A-4C illustrate example order summary pages: an invoice page; the repeated HTML code used to dynamically generate item listing; and an order picture summary.

As can be seen from the drawings, three additional items, category 2 Item 6, category 3 Item 1 1, and category 4 Item 9 were arbitrarily selected prior to loading of the order summary pages.

Recorded data used to generate the order summary pages is as follows:

SHI!Category 1

#1!1!10.00!info001.html!Item 1-1 Descriptive Name!prevs001.jpg!details.gif!

#2!3!10.00!info002.html!Item 1-2 Descriptive Name!prevs002.jpg!10off.gif!”

“SH2!Catagory 2

#6!4!10.00!info026.html!Item 2-6 Descriptive Name!prevs026.jpg!details.gif!”

“SH3!Category 3

#11!1!10.00!info311.i.html!Item 3-11 Descriptive Name!prevs311.jpg!details.gif!

SH4!Category 4

#9!2!10.00!info049.html!Item 4-9 Descriptive Name!prevs049.jpg!details.gif!

FIG. 4A illustrates an order summary page used to complete a transaction and is displayed as an invoice. It is similar to the list format. It is comprised of: Titles and company information 401; date and time 402; quantity text boxes 403 and adjustment buttons; item description hyperlinks 404; item or unit prices 405: item amounts 406; order subtotal 407; shipping 408; tax 409; order total 410; a hyperlink to reload the page to remove zeroed entries 411; a hyperlink to view the order picture summary page 412; text boxes for customer information 413; text boxes for shipping Information 414; buttons to save, recall and delete customer and shipping information 415; payment information 416; and a button for secure checkout 417.

Any previously selected quantities can be adjusted in place by using the adjustment buttons or by entering the quantity directly into the quantity text boxes. Item preview pictures appear in the mouse-over preview window in the top frame when the item description hyperlinks 404 are moused-over. This allows the user to quickly confirm selected items. If there is still user uncertainty, then clicking the item description hyperlinks displays the item description pages with detailed information. If any item is zeroed, its listing can be removed by a clicking hyperlink 411, which directs the browser to an intermediate page, which in turn loads the updated invoice page with the zeroed entry removed. The intermediate page can display additional information including advertisements.

When the quantity adjustment buttons are clicked, the lower frame is clicked, or the tab key is pressed the following are updated. First, the item quantity 403 is multiplied by the unit price 405 and the item amount 406 is displayed. Next the subtotal 407 is calculated and displayed. Shipping 408 and tax 409, are then calculated and displayed. For illustration, it was arbitrarily assumed shipping was 10% of the subtotal and taxes were an additional 10% of the subtotal and shipping for the calculating of order total 410. In practical application, the calculations would be tailored to the vendor requirements using modules for shipping tax and so on. Finally, any transaction amounts 104 a vendor chooses to display are updated and displayed in the top frame.

The next section on the invoice allows entry of customer 413 and shipping 414 information. This layout saves space as the required items are specified internally in the entry text boxes. The user need only type over the default values that are double listed to continually inform the user of the required information. Alerts ensure the required customer information is filled in for on-line submission:

“The ‘Required*’ fields must be filled in to complete your order.”

Customer and shipping data are saved and recalled 415 using a cookie. This eliminates the requirement to retype the information each time the page is loaded or updated. For non secure environments, there is also a provision to delete this data at anytime. Cookies are a known Internet mechanism which server side connections (such as CGI scripts) can use to both store and retrieve information on the client side of the connection. The JavaScript® Language can read from and write to the browser's cookie file using the “document.cookie” function. The use of cookies maintains item selections between sessions for predetermined periods of time.

The next section 416 specifies payment information. As displayed, it is set up for non secure server. After a payment method is selected, the completed order can be printed and mailed, or printed and faxed to the vendor for order completion. To order securely on-line, a secure checkout button 417 is provided to transfer the order to a secure server. This has the advantage of only utilizing the secure server with associated encryption overhead for finalized orders and gives smaller vendors the facility to use third party secure hosts.

One skilled in the art would realize that different page layouts may be required and different submission methods are possible. The invoice page could be hosted on a secure server and there are a variety of encryption methods that could be employed to maintain confidentiality of the financial data. The form fields could be sequentially labeled and submitted using the GET or POST form methods in conjunction with a CGI server. Order information also could be submitted to the vendor using secure HTTPS header cookies or with encrypted e-mail. The order information could be recorded on the vendor's computer for future reference by the user if required.

FIG. 4B is the repeated HTML code to dynamically generate the items rows in the invoice format. Code segments are numbered to correspond to the displayed elements on FIG. 4A. The form also contains a hidden variable 418 used to store the item descriptions so that they can be submitted on-line. The “@P” is used to denote the item numeric position on the summary page table that is distinct from item category position “@j”.

FIG. 4C illustrates an order picture summary. It is similar to the picture format category order page FIG. 2C but displays all items selected from different categories. The order picture summary includes the same items as the invoice page and allows the entire order to be worked with in pictorial fashion. The informational pop-up tag 421 for the selected item preview image also contains the category title for each item. Since the page displays all selected items, the page total 422 corresponds to the order subtotal and is labeled as such. Any selected item quantity can be easily changed in place without having to wait for page reload. There is a repeated hyperlink 423 to the invoice page. The date and time 424 are also displayed. The repeated HTML code dynamically generating the displayed item group is similar to FIG. 2D except the code line at 229 includes item category. Also “@P” replaces the “@j” throughout for item position, as it is an order summary page.

FIGS. 5A-5E illustrate some of the possible variations for category order pages and their associated repeated HTML code for the item display. Three variations presented are: combination, selection drop down boxes, and the starter list format.

FIG. 5A is a combination page blending characteristics of the picture format category order page and the item description page. It is similar to the picture format category order page shown in FIG. 2C except that provision 505 is made for a brief textual description of each item. This format may be appropriate for some vendors; however, considerable scrolling is required to view more than a few items. Input data needed is the same as the list and picture formats, but also includes a brief textual description for each item. FIG. 5B is the repeated HTML code to dynamically generate the item display and the numbering corresponds to the displayed elements in FIG. 5A. One skilled in the art will realize that a variety of combinations and presentations of the list format, picture format, and item description pages are possible.

FIG. 5C illustrates the use of selection drop down boxes 512 to specify different item characteristics such as code, size, color, style, model, and so on. Any number of selections can be used dependent on vendor's requirements. Presented in the list format, drop down boxes also can be incorporated into other page formats. FIG. 5D is the repeated HTML code to dynamically generate the item rows and the code segment numbering corresponds to the displayed elements in FIG. 5C. The “@j” in FIG. 5D is used to denote the item numeric position 1,2,3 and so on. Data required is the same as the list and picture formats. For the selected items displayed in FIG. 5C the corresponding recorded data is:

SH1!Category 1

#1!1!10.00!info001.html!Item 1-1 Descriptive Name!prevs001.jpg!details.gif!0!0!

#2!3!10.00!info002.html!Item 1-2 Descriptive Name!prevs002.jpg!10off.gif!1!3!

The last two entries following the item data are the drop down selection box indexes for color and size as illustrated on FIG. 5C.

FIG. 5E illustrates a starter list format page. It can be used to bring a vendor on-line with minimal data requirements such as: item number, description, and price that are readily available from most accounting databases. It is comprised of: category title 521; the item descriptions 522; the increment adjustment buttons 523, quantity input text boxes 524; the decrement adjustment button 525; the item amounts 526; page total 527 and a page clear button 528. The quantity adjustment buttons have been increased in size to account for the absence of the picture format. It does not include the mouse-over preview images and item hyperlinks. Using multiple starter list format pages and a browser frameset, several hundred items could be placed on-line with a simplified invoice page similar to FIG. 4A. Later the site could be upgraded to include picture format pages and the item description pages if required. FIG. 5F is the repeated HTML code to dynamically generate the item rows and the numbering corresponds to the displayed elements in FIG. 5D. The @j” in FIG. 5F is used to denote the item numeric position 1,2,3 and so on.

Recorded data for the two select items shown on FIG. 5E is:

SHI !Title

#3!1!ITEM 1-3 Descriptive Name!10.00!

#8!1!ITEM 1-8 Descriptive Name!10.00!

The first row is the recorded category data consisting of category identifier and title. The next two rows are the selected item data consisting of item position, the selected quantity, followed by descriptive name and price.

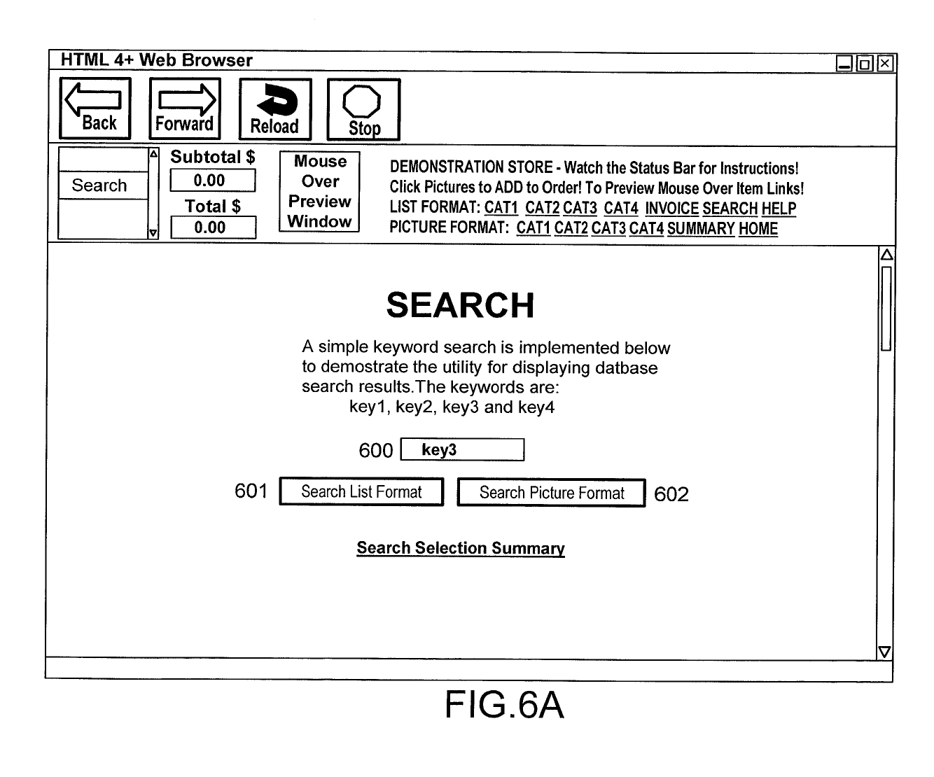

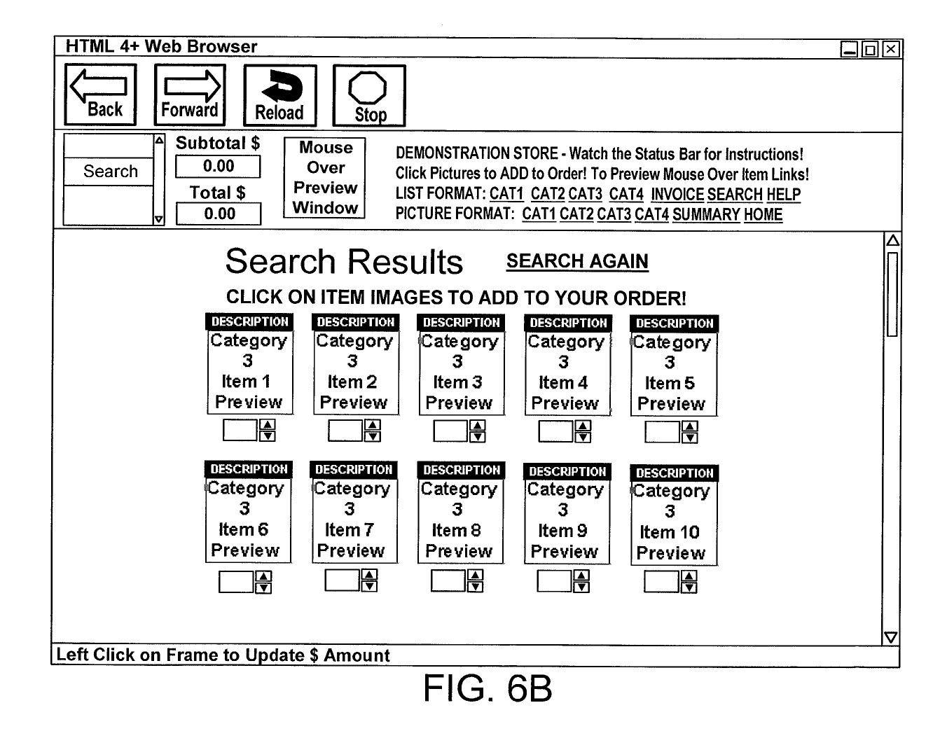

FIGS. 6A-6B illustrate a simple keyword search engine implemented to demonstrate the utility of the invention for displaying database search results. An array with comma separated item data, including a keyword, was used as the database.

FIG. 6A illustrates a search form for search engine to initiate a query 600 and display the resultant search results as either a list format category order page 601 or a picture format category order page 602. FIG. 6B illustrates the results of a keyword search on “key3” in picture format. The advantage of the invention is that items can be immediately ordered-in-place, with multiple selections of varying quantities from the displayed search results.

One skilled in the art will realize that a variety of search routines could be implemented for proprietary and non-proprietary databases on a variety of server platforms. Additional coding will be required to facilitate display of database search results for a specific vendor. Also, one skilled in the art will realize that search results could be obtained from several different vendors.

FIG. 7 shows the performance using the picture format layout displayed in FIG. 6B. Addition was timed for items on Netscape Navigator® and Microsoft Internet Explorer® browsers. The table shows addition times, in seconds per item, for increasing computer processing power and varying number of items per page. Microsoft Internet Explorer® is more constrained in memory usage and hence the slower addition times observed. For the 800 MHz processor and Netscape Navigator®, addition times were no longer limited by processing power and transaction amounts were updated instantaneously. Extrapolating for 100 items, on two category pages the selection time, not including page load, would be just over one minute. This is faster than what is required by a typical user. The list format addition time per item is more dependent on user dexterity due to the small size of the adjustment buttons, but can be only marginally greater than clicking on the picture format images. One skilled in the art will realize that the quantity adjustment component, if included, would increase performance of other e-commerce applications.

Cumulative time required to order will be influenced by network speed. For the selection of 10 items using non-optimized development code, transmission of: the top frame; a list format category order page (FIG. 2A); a picture format category order page (FIG. 2C); and the invoice order summary page (FIG. 4A) requires approximately 50 kilobytes. Assuming 5 kilobytes per item image, 100 kilobytes in total would be required. The selection of ten items with current art typically requires the server to transmit 900 kilobytes to the client to show updated invoice amounts for each item selected. Additionally, the client must transmit about 100 kilobytes to the server during the selection procedure. Approximately a megabyte in total is required. Using one tenth of the network resources, plus whatever additional textual and graphical display the vendor specifies, the invention accomplishes the same task as the current art with greater functionality. In other words, a vendor can present more items and service more customers conveniently with the same resources. As scripting is used to generate the invention's pages, the savings in network resources further increases as more items are displayed.

For a single category, adding ten different items to an order using the invention requires the download of a single page and ten mouse clicks or their equivalent. Transaction amounts are constantly updated with each addition. There is only a single wait for page download using the invention. For the current art that updates the transaction amounts with each addition, there are multiple downloads and the user has to constantly pay attention to complete the process. The single wait can be temporarily overlooked while the multiple waits become extremely frustrating on slower networks. The correction of any entry or change of quantity using the invention requires only a click on an adjustment button. The correction or change takes approximately one second, and is accomplished in place without page load or reload. Further to this, if the user forgets what was previously selected while completing invoice page, moving the mouse over the item descriptive name displays the item image in the mouse-over preview window. If there still any doubt, clicking the item description hyperlink will display the item description page with detailed information.

The invention further removes uncertainty by displaying the current selection of the item(s) when any category, item, or summary order page is loaded. The current selection is always displayed even if the browser recovers an out dated page from the cache when the browser's back and forward buttons are pressed. The user is not required to remember, if and what quantity, of an item was previously selected.

In summary, orders can be made with greater accuracy, in less time, and with less frustration than the current art. The vendor benefits from the greater order accuracy and a decrease in network traffic and server load needed to complete orders. Furthermore, impulse buying is possible. Large orders can easily be completed. A convenient ordering process will likely result in more people shopping on-line.

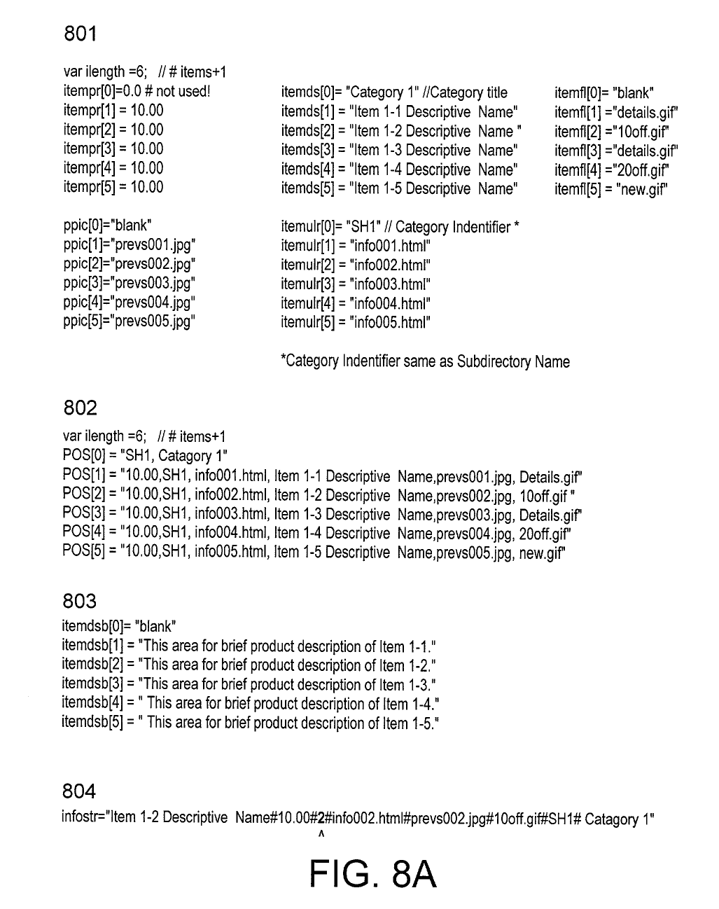

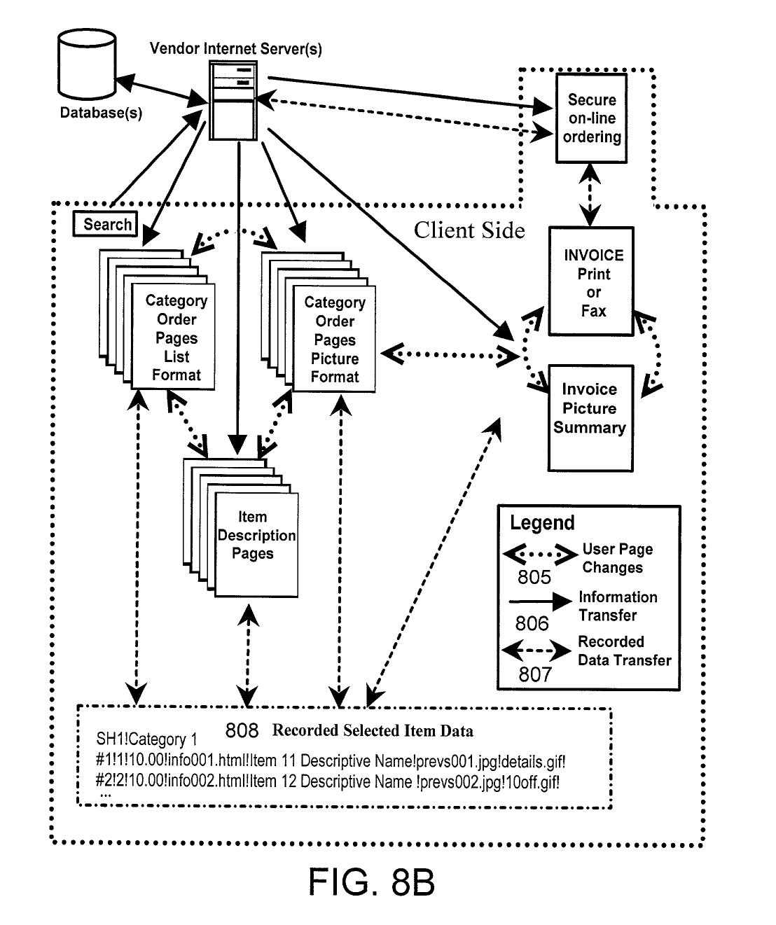

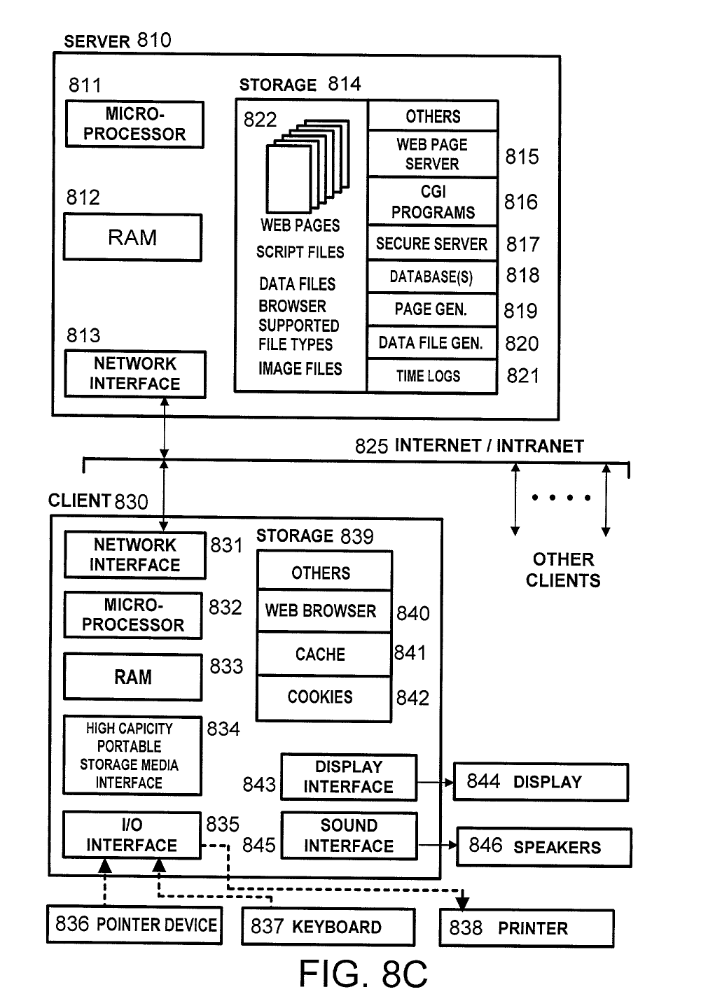

FIGS. 8A-8C illustrate input data structures, a conceptual diagram and a schematic block of diagram of a representative system.

FIG. 8A shows input data used to generate the category order pages and item description order pages. Data is included as script during the page load. Data for category items can be: individual arrays 801; a single array with comma separated values 802; or as a combination of both. Arrays contain values for item price, item descriptive name, hyperlinked rollover images, preview images, and item description page. Additionally, the zero elements in the arrays are used for category data. The advantage of individual arrays is that they can be divided, while the comma separated values can be imported from a spreadsheet allowing several hundred items to be easily administered without a database for some vendors.

The combination page, FIG. 5A requires an additional brief product description 803 while the starter list format, FIG. 5E, requires data as previously indicated. Each item description page requires category and item data as well as the item's category position. The data string 804 was used for the item description page in FIGS. 3A-3B. If required, the routine to pre-load the preview pictures into the browser cache can be included in the script with the input data.

One skilled in the art would realize the following: Additional elements may be required such as item number, weight, item availability and others, dependent on vendor requirements. Additional coding will be required to access values from pre existing vendor databases on various server platforms. Scripting languages allow creation of special variables called “Objects” that could be used to organize data. XML schema also could be used for structure and exchange of data.

FIG. 8B is a conceptual diagram of the preferred embodiment using the list and picture format category order pages previously illustrated in the drawings. It illustrates the relationships between various components of the system. The dotted lines with the line arrowheads 805 show the user page changes possible. Arrows from the invoice and order picture summary to item description pages and the list format category order pages were omitted for figure clarity. Thus, access is provided to any page at any time. The solid lines with triangular arrowheads 806 represent information transfer between the client and server side. The dashed lines with beveled arrowheads 807 shows the recorded data 808 transfers. In the preferred embodiment for illustration of the best mode, current selected item data is maintained solely on the client side using cookies.

The general layout of the category order pages follows:

<html version=4>
<head>
<title>page title</title>
<script src=“Functions.js”></script>
<script src=“Input_Data.js”></script>
</head>
<body onLoad=“Load_function(‘Category Identifier’)”>
<form NAME=“form1”>
<table>
“Table Headers”
<script
LANGUAGE=“JavaScript”>Repeated_HTML_code_function();</script>
“Table Footer with Page Total $ text box”
</table>
</form>
</body>
</html>

The invoice and order picture summary pages are of similar construction to category order pages as shown above except that there is no “Input_Datajs” file. Instead, recorded data is read from the cookies to generate these pages. Upon page load, category order pages and item description order pages also check the cookies for previously selected quantities.

This no limit on the number of categories or items that can be presented; however, constraints are imposed on cookies to limit usage of client side hard disk resources. Current constraints are: cookies are 30 cookies per domain and 4 kilobytes per cookie and a total of 300 cookies per browser user. Large orders with wordy item descriptions may exceed cookie constraints. A number of options are available: instruct the user to split the order into parts for several submissions; the browser could be logged into using several aliases for repeated orders over time; or the vendor could use signed scripts to access additional client resources.

In another embodiment for orders exceeding browser capacity, the selected item data contains minimal information, such as product identifier and quantity. This minimal data would be transmitted vendor's Internet server and the vendor server would supply complete data for the order summary pages to the client. Standard methods for transmitting data to a server are: using a HTML form; or sending the data in cookies that have been generated on the client.

FIG. 8C is a schematic block diagram of a representative system, operating in a Web client-server network environment, according to a preferred embodiment of the present invention. A network 825 interconnects a server computer 810 and a client computer 830. The server 810 is coupled to the network 825 via a network interface 813. Similarly the client 830 is coupled to the network 825 via a network interface 831. The network 825 may be the Internet, which is a vast global Web of interconnecting networks that includes WebTV. It may be smaller Wide Area Network (WAN). It may also be an Intranet, which is operating in a domain of one or more interconnected Local Area Networks (LAN). In general, other servers and clients may also be connected to the network 825.

The server 810 is a computer that includes a microprocessor 811, a Random-Access Memory (RAM) 812, and storage 814. The Storage 814 is typically a nonvolatile mass storage such as magnetic disk drives. The storage 814 stores, among others, a number of Web-specific programs, such as a Web Server 815 a Common Gateway Interface (CGI) 816, Secure Server 817, a data file and page generator 819 and time logs.

When the server is operating as a Web server, the programs are transferred to RAM 812 and are executed from there by the microprocessor 811. The Common Gateway Interface programs 816 handle HTML forms and cookies transmitted using the browser's location bar. The Secure Server program 817 is used for financial transaction data in conjunction with a transaction data base 818.

The page generator 819 and data file generator 820 work in conjunction with an item database(s) 818 for handling search queries. If the scripting files have not been previously downloaded and there are less than 10 items to be displayed, it is more efficient to generate the formatted page on the server for download to the client 830. The page generator 819 is the implementation of the invention on the server 810 using search results with transmission of the display code to the client 830. The data file generator 820 is a routine that formats query results for input data as previously discussed in FIG. 8A. The data file generator is also used for the embodiment with minimal data in the cookie. Database table(s) for queries, based on item code, would contain an input data string similar to that used for item description page 804 for each item. A query of an item database(s) using the item code would return complete item data for generation of the order summary pages to the client. One skilled the art would realize that database queries and their use are well known and the database(s) 818 can be implemented with any number of database programs. The exact code structure of the data file generator depends on the internet server, database type, database structure and vendor data requirements.

The time logs 821 are server programs that record page access times amongst other server events. The storage 814 also stores a collection of Web pages, script files, data files, and images, as well as any file type supported by the browser 822. Each is addressable by its unique Universal Resource Locator (URL). The Web pages are: order pages, order summary pages, site navigation pages, and other informational pages. An opening frameset is typically included.

The client 830 is another computer on the network that includes a microprocessor 832, Random-Access Memory (RAM) 833, a network interface 831 and storage 839. The network interface 831 is typically a fax modem or cable modem. A pointing device 836, such as a mouse or its equivalent, a keyboard 837 and a printer 838 are coupled to the client 330 via an I/O interface 835. The client 830 also has speakers 846 connected via sound interface 845 and a drive for accessing high capacity portable storage media 834.

The client storage 839 is typically a non-volatile mass storage such as a magnetic disk drive. The storage 839 stores among others a Web browser program 840 that is compliant with HTML version 4+ and has the cache 841 and the cookies 842 enabled. A Web page is displayed by client 830 on a display 844 via a display interface 843. A hyperlink is actuated opening the initial frame set using the pointing device 836. Web pages, script files, data files and other file types downloaded from the server 810 are transferred to the client's RAM 833 and are executed from there by the microprocessor 832. The browser saves Web pages and images to the cache 840 while the “<script src=”scripts.js“></script>” only reside in RAM 833 during operation. Item selections are saved in cookies 842 in the preferred embodiment. Since browsers support audio format files, speakers 845 are present.

The SRC attribute of the JavaScript <SCRIPT SRC=“data_file.js”></SCRIPT> can use the complete Universal Resource Locator (URL). In yet another preferred embodiment using two data files, a vendor could distribute portable computer-readable media, such as a CD-ROM or DVD, without price and availability information. Both CD-ROMs and DVDs are in common use and their methods of manufacture are well known.

At the time of page load, the current price and item availability would be downloaded from the vendor's server. The HTML header would have following layout:

<html version=4>
<head>
<title>page title</title>
<script src=“http://www.vendor_server.com/Subject_to_Change_Data.js”></script>
<script src=“Client_Functions.js”></script>
<script src=“Client_High_Density_Data.js”></script>
</head>
<body onLoad=“Load_function(‘category Identifier’)”>
. . .

In the preceding code segment, the “onLoad” event handler delays the Load function until the document is complete. This enables a vendor to distribute extensive detailed item information saving network transmission costs and the time delays for network download are eliminated. Additionally, vendors need only update their server to effect price changes.

If the server data is unavailable, it is possible to detect the error condition and inform the user of suggested remedies. One of these remedies being, to assign zero price to each item and use the system for item quantity selection only. The specified transaction amounts would be calculated later and may be completed on another system. Used in this mode, due to speed of selection, it also could be used for quotations and other inventory management operations either off-line or on-line.

One skilled in the art would realize that all files could be distributed on portable media and the order can be completed off-line by fax or mailing. One skilled in the art also would realize that script files could be maintained on another server so that a licenser can collect royalties from several vendors using the invention.

FIGS. 9A-9F illustrate: the quantity adjustment component; a simplified block flow diagram of the running subtotal procedure for order pages; a simplified block flow diagram of the order subtotal procedure for order summary pages; a simplified block flow diagram of the order subtotal procedure for order pages and deferred calculation procedures for order pages.

FIG. 9A shows a displayed item element of the quantity adjustment component with the associated HTML 4 code. For clarity, the table tags defining the display structure are not in bold type and the “#” sign has been used to denote the generalized positional value of an item displayed on a page. For the category order pages “@j” can be substituted for the “#” symbol. For the order summary pages the “@P” can be substituted for the “#” symbol. Reference numbers on the HTML code segments are repeated and correspond to displayed elements in the drawing. The quantity adjustment component allows selection and adjustment of multiple item quantities without using the keyboard.

The quantity text box 901 has the “onchange” event handler that updates the order calculations when an item quantity is changed. The “update_function” refers lower loops of the procedures in FIG. 9B, FIG. 9C, and FIG. 9D. Thus, transaction amounts are continually updated upon selection or change in item quantity. The increment indicator image 902 of the adjustment buttons has been hyperlinked to an Add function that reads the quantity in the quantity text box 901 and increments the read quantity by one. The decrement indicator 903 has been hyperlinked to the Add function that reads the quantity in the quantity text box and changes the read quantity by minus one. Both indicator hyperlinks have “onMouseOver” event handlers that display flattened images to inform the user which indicator the mouse pointer is referencing. The mouse pointer 904 caused the flattened image to be displayed for the decrement indicator.

The following JavaScript® code segment is the Add function:

function Add(increment_value,#) {
num = eval(‘document.form1.E_quan’ + # + ‘.value;’);
num=num*1+j*1
if (num == isNaN(num)) {
num=0
}
else {}
if (num <= 0) {
num = 0
}
else {}
eval(‘document.form1.E_quan’ + # + ‘.value = num’);
update_function(#)
}

The Add function first reads the text box for quantity, converts the text to numeric value, and adds the increment value also converted to numeric value, for the new quantity. Two checks set the quantity to zero, if the quantity is not a positive value. This ensures valid data is used in subsequent calculations. Other criteria can be included to further enhance the reliability of the calculations if required. The document is then updated with the new quantity and the update_function initiates the order calculations. Thus, the user needs only a mouse click to add to the order and be informed of the item amount and specified transaction amounts.

The quantity adjustment component can include additional display elements. The picture format, combination format, and item description pages allow the option to left mouse click on the item images to add to the order. Code segment 225 in FIG. 2D for the picture format shows the hyperlinking to the item image that calls the JavaScript® Add function, which adds one item to the order per click. Alternatively, if no image is available then small font pre formatted text can be used in place of the image.

Other variations and configurations are possible to meet specific applications. If a user is familiar with the system, only the decrement indicator with optional display element is required. If needed, two or more quantity adjustment components could be placed in a row for increments of tens, hundreds and so on. One skilled in the art would realize that the mouse click has numerous equivalents using other pointing devices and that the increment value could be any specified amount. The quantity adjustment component could be utilized for a number of different purposes on Web pages. Some of the possible uses are auction bidding, stock trades, commodity trades, and inventory management. The quantity would refer to the number of currency units per item where applicable.

It should be noted that although the quantity adjustment component has been displayed in all screen shots of the best mode of the invention, the invention will function without the quantity adjustment component. One skilled in the art will realize that the invention could utilize other methods of conveniently adding items to an order dependent browser capability.

The following three drawings illustrate the running subtotal and order subtotal procedures implemented in the category order pages, item description order pages, and the order summary pages:

FIG. 9B illustrates the running subtotal procedure for using a simplified block flow diagram. The running subtotal procedure can be used for category order pages and item description order pages. This procedure is optional, as the recorded data can be used for all calculations.

In block 910, all previously selected item(s) are recalled for the page. The page total is calculated and recorded in block 911 using the recalled item quantities multiplied by price. In block 912, the running subtotal is recalled. If there are no previous item selections from any category, then the subtotal is zero, otherwise it is the running subtotal for all selected items from every category. In block 913, the specified transaction amounts are updated and displayed in the top frame based on the recalled subtotal.

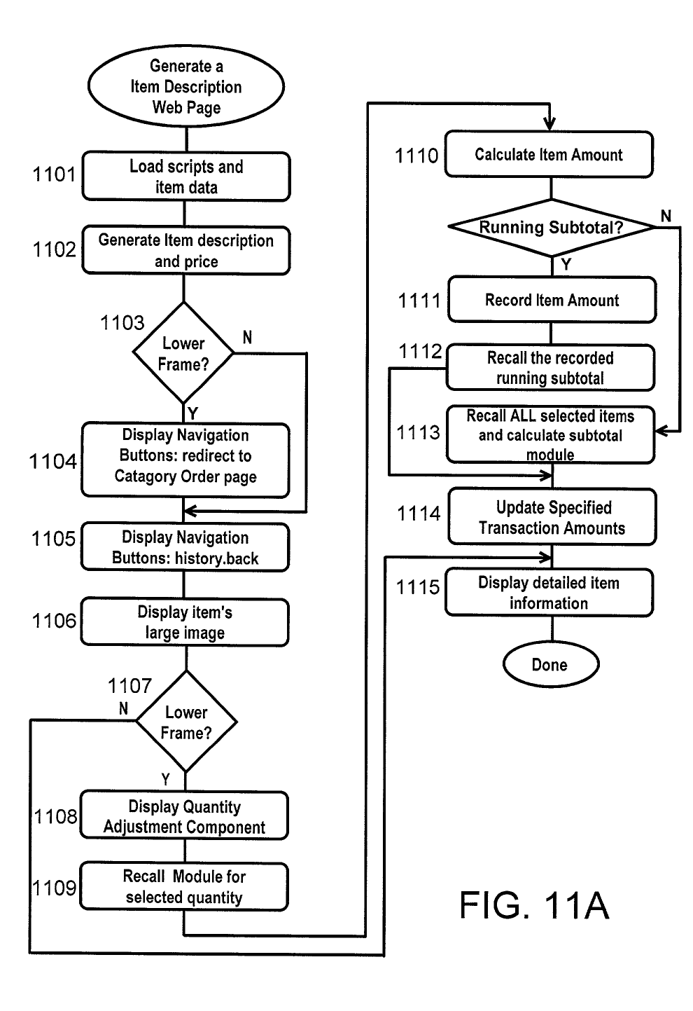

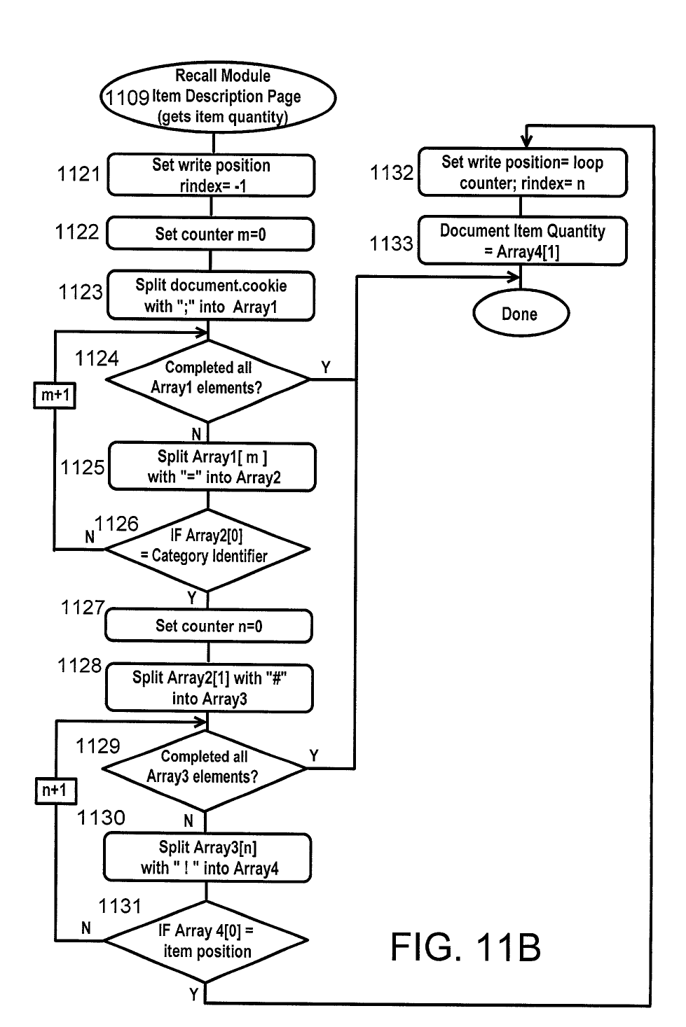

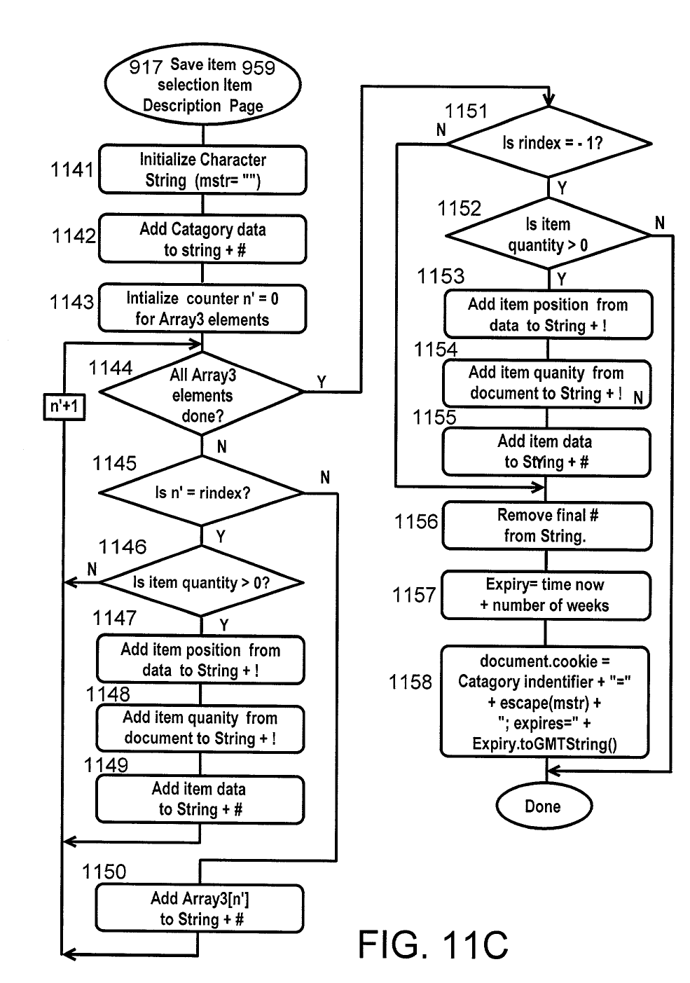

At block 914 the routine pauses waiting for an item selection or change in item quantity initiated by the user in block 915. Upon item selection or change in item quantity, the item amount 916 is calculated. The item selection is recorded in block 917. Blocks 1041-1052 in FIG. 10C save the item selection for a category order page, while blocks 1141-1158 in FIG. 11C save the item selection for item description order page. These routines are discussed in depth with their respective figures. Once either routine completes, the procedure returns to FIG. 9B and a new page total is calculated in block 918. For the first change of item selection after page load, the change in page total is calculated in block 919 using the page total that was initially stored in block 911. The new page total calculated in block 918 is stored in memory 920 for the next change in page total calculation. The current change in page total, either positive or negative, is added to the subtotal in block 921 for a running subtotal. Optional alerts in block 922 instruct the user to go to an order summary page, if the subtotal is negative or non-numeric. This will be discussed in detail subsequently. The running subtotal is recorded in block 923. If the running subtotal is recorded to the client's storage, it also maintains the subtotal between browser sessions. In block 924, the specified transaction amounts are updated and displayed in the top frame. The routine returns to the pause in block 914 waiting for the next item selection or change in item quantity initiated by the user. The procedure exits once the user is satisfied with their item selections and navigates to another page.

One skilled in the art would realize that the order subtotal is the most logical value to use for facilitating future calculations between pages and order sessions. However, other values could be used including the order total. Specified transaction amounts can be any that the vendor chooses.

When using the running subtotal, items selected and added may not be always properly saved to the recorded selected item data. Initial characters of the cookies may be undefined or not written. The malformed cookie will not be properly recalled and its selected items will be dropped from the order. Consequently, the running subtotal does not display the actual order subtotal. This error condition can be corrected by loading a page using the order subtotal calculated from the recorded data, such as the invoice page.

Optional alerts used in block 922 of FIG. 9B used to inform the user of detectable errors are as follows: If the result of the running subtotal calculation is not a number (NaN) then the following alert is issued:

“OOPS, there has been a processing error!

Please ensure the page total is not “NaN”.

Then proceed to an order summary page to reset the $ Totals.”

If the result of the running subtotal calculation is negative, then the following alert is issued:

“OOPS, there has been a processing error!

Please proceed to an order summary page to balance the $ Totals.”

The running subtotal is faster than recalling all the selected items and is advantageous for slower computer processors. Discrepancies are infrequent enough that the faster method is desirable but the optional alerts and the change to an order summary page makes the system more reliable and does not leave the user wondering why the displayed specified transaction amounts are not correct. One skilled in the art would realize that the correction could be done automatically without user intervention or page load.

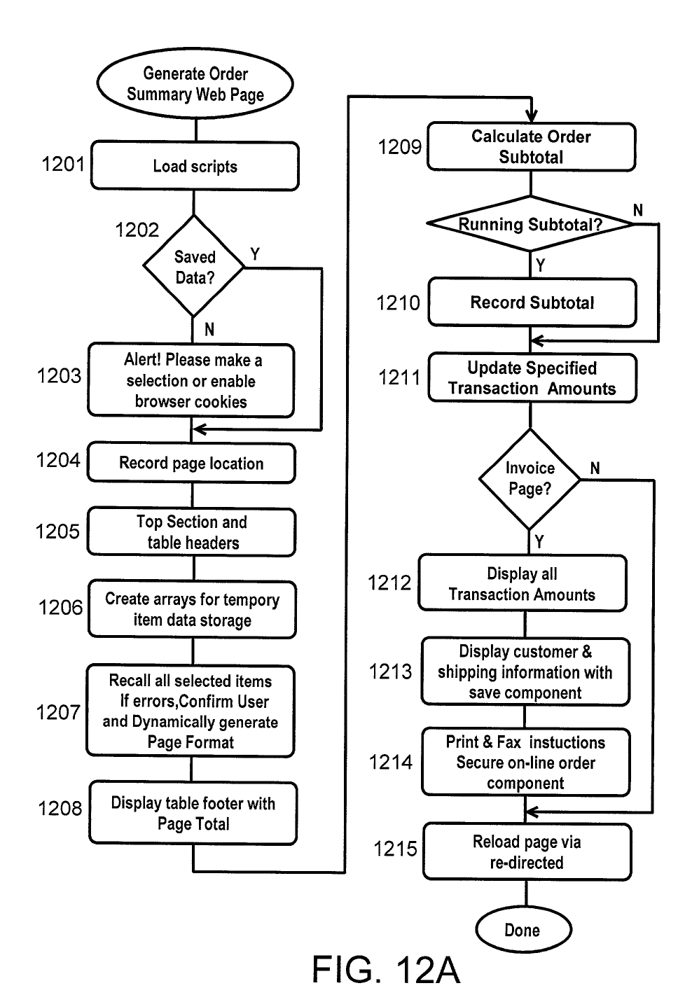

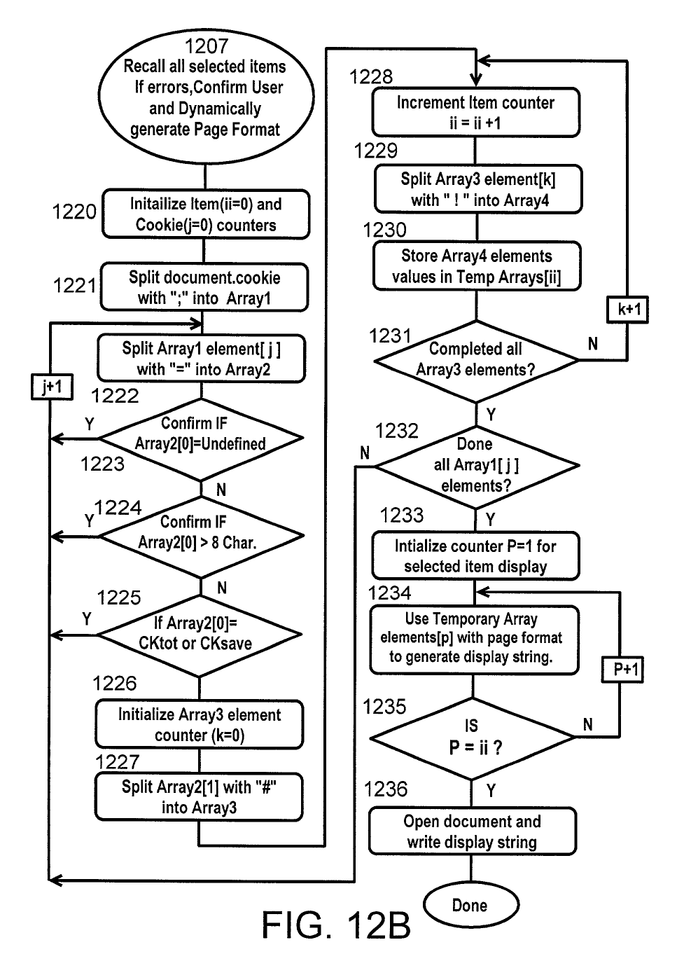

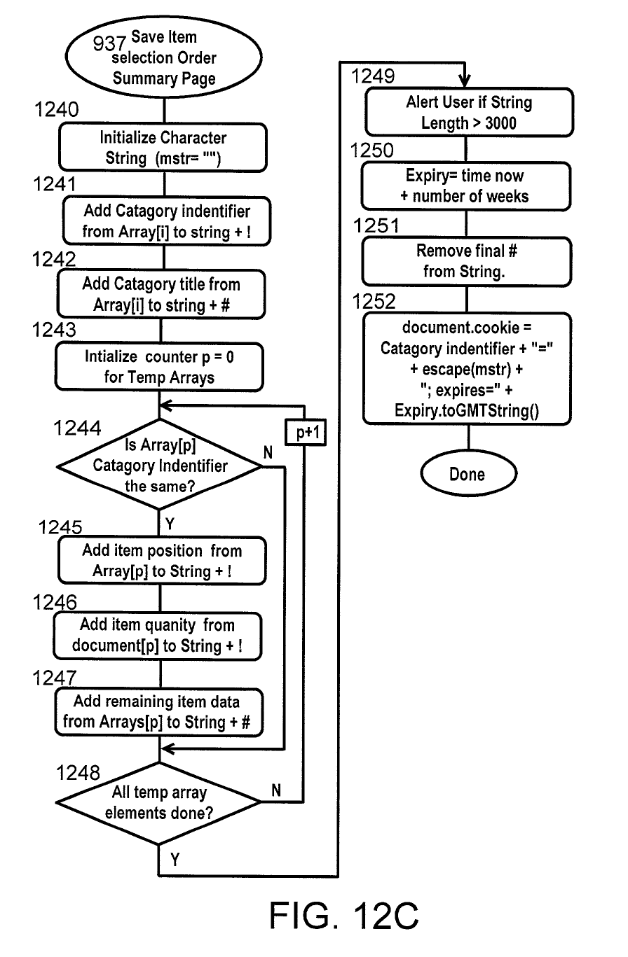

FIG. 9C is a simplified block flow diagram of order subtotal procedure that is used for order summary pages. All previously selected items are recalled in block 930. This is implemented during page generation using blocks 1201-1215 in FIG. 12A and blocks 1220-1236 in FIG. 12B. Refer to the drawings for the detailed discussion. The procedure returns to FIG. 9C and the order subtotal is computed in block 931 using the recalled values. If the order pages are using a running subtotal, then the order subtotal is recorded in block 932. This resets any discrepancies between the running subtotal and what is actually recorded to the order in the selected item data. In block 933 the required total invoice amounts are updated and displayed.

At block 934 the routine pauses waiting for an item selection or change in item quantity initiated by the user in block 935. Upon item selection or change in item quantity, the item amount is calculated in block 936. The item selection is recorded in block 937 using the subroutine routine in blocks 1240-1252 of FIG. 12C. Block 938 calculates the order subtotal using the displayed values on the summary page. If a running subtotal is used, the order subtotal is then recorded in block 939. The required invoice amounts are updated in block 940. The routine then returns to the pause in block 934 waiting for the next item selection or change in item quantity initiated by the user. The routine exits once the user is satisfied with their item selections and navigates to another page.

FIG. 9D is a simplified block flow diagram of the order subtotal procedure that is used for order pages. This procedure is integrated into both category order pages and item description order pages. It calculates the subtotal from the recorded data and therefore the page total and the recording of a related value for subsequent calculations are not required. As it recalls all selected item data for each selection or change in item quantity, it is more processor intensive. It is useful for handling complex tax and other calculations.

All selected items for the order page are recalled in block 950. This is done during page generation. For a category order page, blocks 1001-1018 in FIG. 10A and blocks 1021-1032 in FIG. 10B are used. For an item description order page, blocks 1101-1115 in FIG. 11A and blocks 1121-1133 in FIG. 11B are used. Next, the page total is optionally calculated in block 951 for display. As all items selected for the order may be not displayed on one of several order pages, they must be recalled in block 952 using the recorded data. The order subtotal is calculated in block 953. For computational efficiency, blocks 952 and 953 are implemented in a loop that repeatedly recalls each selected item and incrementally computes the subtotal as shown in blocks 1060-1073 of FIG. 10D. Included in the loop are error detection blocks 1064-1065 that optionally inform the user of any errors made by the browser recording the selected item data. In the last step to complete the document load, order transaction amounts are updated and any specified transaction amounts are displayed in block 954.

The procedure then pauses 955 waiting for a user item selection or a change in item quantity 956. Upon selection or change, the item amount is optionally calculated and displayed in block 957. The page total is optionally calculated in block 958 for display. The revised item selection is next recorded in block 959. Blocks 1041-1051 in FIG. 10C are used for a category order page and blocks 1141-1158 in FIG. 11C are used for an item description order page. Next, all items in the order are recalled in block 960. The order subtotal is calculated in block 961. Blocks 1060-1073 in FIG. 10D, which include the optional error detection blocks 1064-1065, are used again to inform the user of any errors recording the item data. Next, the order transaction amounts are updated and any specified transaction amounts are displayed in block 962. The routine returns to pause 955 waiting for the next item selection or a change in item quantity. The routine exits once the user is satisfied with their item selections and navigates to another page.

As selected item data is saved by category, any error on saving the data will be immediately displayed by blocks 1064-1065. Thus, it is only necessary to instruct the user to re-enter the category item selections. The following confirm is used:

“OOPS your Browserjust lost one of its Cookies!

Please re-enter your category selections.

Do you want to stop these messages? Yes/No”

Saving selected item data by categories confines the loss of item selections to a category.

In another embodiment, item data is saved using one or more of cookies in a series for selections from multiple categories. However, there is possibility of a loss of all item selections or several items from several categories that would frustrate a user. To prevent item data loss, data could be recovered from the cookie fragment, backed up in memory or saved to a duplicate set of cookies. Longer download times would result from the additional code to handle the complexity of these solutions.

The recording of the item selection data upon every selection or change of item quantity uses the hard drive every time a cookie is saved. This may be detrimental to the hard drive of a computer used exclusively for ordering. Instead, recording of item selection data could be deferred until document is unloaded using “onUnload” and “onBeforeUnload” HTML body tags for Microsoft Internet Explorer®. These body tags are not supported by Netscape Navigator® and an additional element is required to initiate the deferred recording of the item selection data. One possible configuration would be to disable the browser navigational buttons and initiate deferred recording using the “onMouseOver” event handler for the navigational links. From the user's stand point, if the running subtotal is used, these implementations of the invention produces the similar result to the record of item data upon selection or change. If the recorded selected item data is used to update invoice amounts, then the update of invoice amounts also would be delayed for this configuration.

FIG. 9E and FIG. 9F illustrate the delay procedures discussed above for the running subtotal and order total respectively. Block 970 refers to “onUnload, “onBeforeUnload” and “onMouseOver” event handlers while remaining blocks in the diagrams are rearrangements of the loops in FIG. 9B and FIG. 9D. Other re-arrangements are possible.

JavaScript® is used to implement the present invention. One skilled in the art would realize that other programming languages and scripting languages could be used to implement the invention. Multiple options are currently available and as browsers and languages evolve more options will likely become available.

FIGS. 10A-10D are simplified block flow diagrams of the routines that generate category order pages, recall selected items, save selected items, and calculate the order subtotal from recorded data.

FIG. 10A is a simplified block flow diagram of the routine that generates a category order page. The script files and category data file are loaded in block 1001 into computer memory.

Category name and the lower frame Universal Resource Locator (URL) in block 1002 are stored in hidden text box fields in the upper frame for future reference. If the page is list format, the item preview pictures are pre-loaded in block 1003 into the browser's picture cache. The page category title and the table headers are displayed in block 1004. In block 1005 a counter is set with “j=1” and the character string is initialized to a null value. Using the input data @j and HTML format @j, the category item is added to the character string in block 1006. The “+=” assignment operator is used to build the display string. Recall that FIG. 8A presented the input data structures while FIGS. 2B, 2D, 5B, 5D, and 5F presented repeated HTML code segments for category order pages. A check is made in block 1007 to determine if all items are completed. If not, the counter “j” is incremented and the loop continues until all items are completed. As the string is in script, all quotation marks are preceded by a “\” backslash so that they are displayed as characters when the string is written to the document in block 1008. It also would be possible to do this statically, that is, to create and edit a template but the procedure would be time consuming and prone to mistakes. The table footer that includes the page total text box is displayed in block 1009. The quantity text boxes on the page are cleared in block 1010 to prevent outdated entries from being displayed on a cached page when the browser's back button is pressed. The current item selection for the category page is recalled and displayed from the recorded selected item data in module 1011 using blocks 1020-1032 of FIG 10B.

If the running subtotal procedure of FIG. 9B is used, block 1012 calculates and stores the page total into a hidden variable for the first calculation of change in the page total. The recorded running subtotal is recalled in block 1013.

If the order subtotal procedure of FIG. 9D is used, the page total is optionally calculated and displayed in block 1014. All items are recalled from the recorded data and the subtotal is recalculated in block 1015 using the computationally efficient routine in blocks 1060-1073 of FIG. 10D. Next, transaction amounts are updated in the top frame in block 1016. If the category order page is list format, a clear button is displayed in block 1017 and a picture summary of the previously selected items for the category is generated in block 1018. Modified picture format code (FIG. 2D) is used to generate the string for selected items in an analogous fashion to blocks 1005 through 1008 for the display of the selected item pictures.

FIG. 10B is a simplified block flow diagram of the module 1011 in FIG. 10A that recalls previously selected items for a category order page. The document.cookie is split with a semicolon in block 1020 into Array1 whose elements contain data character strings recorded from active category pages. An array element counter is initialized in block 1021 and a loop begins. A check 1022 is made to ascertain if all Array1 elements are completed. If true, the routine exits. Otherwise the loop continues and Array1 elements are sequentially split into Array2 elements in the loop using an equal sign “=” in block 1023. The loop also exits if the first element of Array2[0] is equal to the category identifier in block 1024. Upon this exit, the previous category character recorded data string is equal to the second element of Array2[1]. The recorded data string is split with the primary separator “#” in block 1025 into Array3. An element counter for Array 3 is set in block 1026. Next, each element of Array3 is split in block 1027 with the secondary separator “!” into Array4.

Array4 elements contain item data. The first element Array4[0] is item position while the second element Array4[1] is item quantity 1028. The recalled item position is used to calculate the corresponding form element index for displaying the quantity in block 1029. Next, the recalled item position is used to get item price from the input data and the item amount is calculated in block 1030. The recalled item position is used to calculate the corresponding form element index for displaying the item amount in block 1031. Finally, a check is made in block 1032 to determine if all Array3 elements or selected items have been completed. If not, the routine continues at block 1027 with the next Array3 element, until all selected items are displayed.

FIG. 10C is a simplified block flow diagram for blocks 917 and 959 in FIGS. 9B and 9D respectively that save item selections for category order pages. First, a character string in block 1041 is initialized to a null value. The category data in block 1042 delimited with secondary separator “!” is added to the data string. A loop index is initialized in block 1043 to read all selected quantities from the category document. A check in block 1044 is made to determine if the item quantity on the document is positive. If it is not positive, the loop counter is incremented and the next item quantity on the document is checked. If the item quantity is positive, then a primary separator “#” is added in block 1045 to the data string that demarcates the data for the individual selected items. The loop index plus the secondary separator “!” are added to the data string in block 1046 recording the item position on the page. In block 1047, the item quantity from the document plus the secondary separator “!” are added to the data string. Input item data, referenced by the loop index and required for the order summary pages, is added to the data string delimited by the secondary separator “!” in block 1048. A check is made to determine if the all items in the category have been completed in block 1049. If not, the loop indicator is incremented and the routine starting at block 1044 is repeated for the next item position.

Once all category items have been completed, an alert in block 1050 is used to inform the user if the data string is greater than 3000 characters and approaching the browser's cookie size limit.

“Reaching category capacity. Please order your selected items now. Then delete all ordered items and add additional items you desire for a second order. Thank you for your patronage. Note Microsoft Internet Explorer® 4 will remove all your selections if more are added!!! Netscape Navigator® 4 will allow a few more additions then ignore the rest.”

Selected item data is recorded for every item selection. Thus, incremental character length for saved data is only one item's data character length greater than 3000 characters. For the 18 character descriptions, used in FIG. 2A, the 3000 character limit allows 66 items to be selected per category. This could be increased by renaming the repeated element names to one or two characters or the vendor may use signed scripts or the embodiment with minimal recorded data as previously mentioned.

Next, in block 1051 an expiry date based on the current time, plus a predetermined number of weeks is calculated in milliseconds since Jan. 1, 1970. The expiry time can be chosen to facilitate recurrent orders to suit the vendor's and user's requirements. The final block 1052 saves the data string with the “document. cookie” function. The cookie syntax is: the category identifier, an equal sign, the escaped data character string, “; expires=”, and the expiry date converted to Greenwich Mean Time.

One skilled in the art would realize that data string compression could be used to extend the order capacity. Additionally, other data could be added to the data string, such as selection time and session identifier, for marketing information.

FIG. 10D is a simplified block flow diagram of the computationally efficient routine that recalls all selected items from recorded data and calculates the order subtotal incrementally. The routine handles blocks 952-953 and blocks 960-961 for order subtotal procedure for order pages outlined in FIG. 9D. The routine is implemented in block 1015 of FIG. 10A for category order page, and in block 1113 of FIG. 11A for item description order page.

A subtotal variable is set to zero in block 1060. Next two counters are set in block 1061; one for the number of selected items and one for the number of category cookies. The document.cookie is split with a into Array1 in block 1062. Next each element of Array1 is split in block 1063 with an equal sign “=” into Array2. The first element of Array2[0] is run though a series of checks. First two, checks are run to determine if the browser correctly saved the category selection information. In block 1064, the following confirm dialogue is displayed if Array2[0] is undefined:

“OOPS your Browser just lost one of its Cookies!

Please re-enter your category selections.

Do you want to stop these messages? [Yes/No]”

In block 1065, if Array2[0] is greater than 8 characters, a predetermined category identifier limit, the same confirm above is displayed. Recorded selected item data is by categories, and this limits the loss of item selection to a category that can be immediately re-entered. Confirms are used so the message can be turned off once the user is aware of the error.

Next, in block 1066, Array2[0] is checked is made to determine if the element is the running subtotal data or the customer information. If any previous checks are true, then the loop counter is incremented and the next element of Array1 is considered. If all checks are false, a counter is set in block 1067 to count the number of selected items (k=0) in the category The second element of Array2[1] is split in block 1068 with the pound sign “#” into Array3. The item counter is incremented (ii=ii+1) in block 1069. Element[k] of Array 3 is split in block 1070 with the secondary separator “!” into Array4. Array4 elements contain the selected item data. At block 1071, the subtotal, initialized at block 1060, is summed using the quantity multiplied by the price for each item obtained from Array4 elements. Block 1072 ensures all category items (Array3 elements) are completed, and block 1073 ensures all categories (Array1 elements) are completed.

FIGS. 11A-11C are simplified block flow diagrams of the routines that generate an item description page, recall a selected item, and save a selected item. If displayed in the lower frame, then the quantity adjustment component is included and the page becomes an order page.

FIG. 11A is a simplified flow diagram to generate an item description page. The scripts and item data are loaded into computer memory in block 1101. The descriptive item name and price in block 1102 are displayed on the document. A conditional in block 1103 determines if the page is the lower frame or a pop-up window. If the page is displayed in the lower frame, the navigation buttons in block 1104 are displayed with the back button (316 FIG. 3B) navigating to the opening page. If the page is displayed as a pop up window, the back button (303 FIG. 3A) in block 1105 refers to the previous document in the browser window. The item's large image is displayed in block 1106. Another conditional in block 1107 again determines if document is in the lower frame. If the page is not in the lower frame, the detailed item information is displayed in block 1115 and the page is completed. If the page is in the lower frame, then the quantity adjustment component is displayed in block 1108. The item quantity is recalled by a module in block 1109 that performs blocks 1121-1133 in FIG. 11B. The item amount is calculated in block 1110.

If the running subtotal procedure in FIG. 9B is used, the item amount is stored in block 1111 into a hidden variable to facilitate the first calculation of change in the page total. The running subtotal is recalled in block 1112. If the order subtotal of FIG. 9D is used, all items are recalled from the recorded data and the subtotal is recalculated in block 1113 using the computationally efficient routine in blocks 1060-1073 of FIG. 10D. Next, the transaction amounts are updated in the top frame in block 1114. Finally, the detailed item information is displayed in block 1115 and the page is completed.

FIG. 11B is a simplified block flow diagram of the recall module routine 1109 in FIG. 11A that recalls the item quantity for an item description order page. A variable “rindex” set to minus one in block 1121 is subsequently used to record the item category position in the data string. The loop counter “m” set in block 1122 subsequently counts category cookies contained in Array1 elements. The document.cookie is split in block 1123 with a “;” into Array1.

A loop in blocks 1124-1126 is used to recover the category data if the category is active. A check is made in block 1124 to determine if all Array1 elements are completed. If true, the routine exits. Otherwise, the loop continues and each Array1 element is split in block 1125 with an “=” into Array2. Array2[0], the first element, is compared to the category identifier in the input data in block 1126. If the check in block 1126 is true, the category is active. The loop exits and another loop counter “n” is set equal to zero in block 1127. Array2[1], the second element, is split in block 1128 with the “#” the primary separator into Array 3 whose elements contain the selected item strings for the active category.

A loop 1129-1131 determines if the item was previously selected. A loop check is made in block 1129 to determine if all Array3 elements are completed. If true, the routine exits. Otherwise, the loop continues and each Array3 element is split in block 1130 with an “!” into Array4. A check is made in block 1131 to determine if Array4[0] is equal to the item position in the input data. If the check is true, the item has been found and the loop exits. The variable “rindex” is set to “n” in block 1132 and this value is used for saving item selection in FIG. 11C. Finally in block 1133, the item quantity is set to Array4[1], the second element, and displayed on the document and the routine exits.

FIG. 11C is a simplified block flow diagram of the routine to save item selections for an item description order page used in block 917 in FIG. 9B and block 959 in FIG. 9D. The routine handles three cases: no previous category item selections; previous category selections but the item not previously selected; and the item previously selected. It works in conjunction with the “rindex” variable and Array3 elements that were created during page load by the recall module of FIG. 11B.

A null character string is initialized in block 1141. The category data plus a “#” in block 1142 is added to the string. A counter “n′=0” is initialized in block 1143 for a loop to consider all Array3 elements. The loop 1144-1150 adds all previously selected category items to the string and a change of quantity for the displayed item from the document if previously selected. A check in block 1144 is made to determine if all Array3 elements are completed. If true, the routine proceeds to block 1151. Otherwise, the loop continues and “n′” is compared to “rindex” in block 1145. If “n′” equals “rindex” and the document item quantity is greater than zero from the check in block 1146 then: the item position in block 1147 is added to the string; the item quantity from the document in block 1148 is added to the string; and the remaining item input data delimited by the secondary separator followed by a “#” is added to the string in block 1149. If “n′” does not equal “rindex”, then element Array3 [n′] is added to the string in block 1150. This block simply adds other category item selections to the string.

Once all Array3 elements have been completed, a check is made in block 1151 to determine if “rindex=−1”. If it does, then the item was not previously selected and check is made in block 1152 to determine if the document quantity is greater than zero. If there is no item selected, then the routine simply exits with no change to saved data. If “rindex=−1” and the document quantity is greater than zero then: the item position from the input data in block 1153 is added to the string; the item quantity from the document in block 1154 is added to the string; and the remaining item input data followed by a “#” is added to the string in block 1155. Next, in block 1156, the final “#” is removed from the string. An expiry date in weeks is calculated in block 1157 and the final string is saved to storage in block 1158 with the document.cookie function. At block 1151, if “rindex” was not equal to minus one, then the routine continues at block 1156 saving the string data accumulated in the loop 1144-1150 with the document.cookie function.

FIGS. 12A-12C are simplified block flow diagrams of the routines that generate order summary pages, recall selected items, and save selected items.

FIG. 12A is a simplified block flow diagram of the routines that generate an order summary page. The scripting files are loaded in block 1201 into computer memory. A check is made in block 1202 to determine if there are any selected items to be recalled. If not, the following alert in block 1203 is issued.

“Please make a selection or enable your Browsers Cookies.

Microsoft Internet Explorer@: View→Internet Options . . . Advanced Tab→Cookies Netscape Navigator®: Edit→Preferences . . . Advanced→Accept all Cookies.”

The page location is stored in top frame in block 1204 for future reference. The page and table headers are displayed in block 1205. The invoice format has company information and data required for a printed invoice, while the order picture summary page headers are similar to picture format category order page. Arrays, one for each item data field, are created in block 1206 to store the selected item data temporally. This saves loading data for each category and retains the category position index for each item. Consequently, the vendor can include an unlimited number of categories. The temporary array indices are used to correspond to the item positions on the order summary page. The page format, either invoice or order picture summary, is dynamically generated in block 1207 using blocks 1220-1236 in FIG. 12B to inform the user of any recording errors and concurrently to store item information into the temporary arrays. Next, the table footer with the page total text box corresponding to order subtotal is displayed in block 1208. The page total corresponding to the order subtotal is calculated in block 1209 from the page entries.

If the running subtotal procedure of FIG. 9B is being used, then the subtotal is recorded in block 1210 resetting the running subtotal for the category and item description order pages. Next, block 1211 updates the specified transaction amounts in the top frame. If the summary page is invoice format: all transaction amounts such as the shipping, tax, order total and so on are displayed in block 1212; customer and shipping information section with the save component are displayed in block 1213; and the Print & Fax instructions and Secure on-line order section are displayed in block 1214. Finally, the page is reloaded using a redirection page in block 1215. The reload is necessary since pressing the browser's back button might cause the browser to load a previously cached page with outdated item selections. As the order summary pages use an intermediate page to ensure current selection, the intermediate page can display additional data or present an advertisement to the user.

FIG. 12B is a simplified block flow diagram for block 1207 in FIG. 12A, which recalls all selected items and issues confirm dialogues informing the user if there are errors while dynamically generating the order summary page. Block 1220 initializes two counters. One that counts the total number of items (ii=0) selected from all categories and one that counts the cookies (j=0) for each active category. The document.cookie is split in block 1221 with a semi colon “;” in to Array1. Next, each element of Array1 is split in block 1222 with an equal sign into Array2. The first element Array2[0] runs through a series of checks.

First, two checks determine if the browser has correctly saved the category selection information. The following confirm dialogue 1223 is displayed if Array2[0] is undefined:

“OOPS your Browser just lost one of its Cookies!

The following information is being ignored:”

‘Cookie fragment consisting of constructed category selection data string.’

“The corresponding items to above may have been dropped from your order!

Do you want to stop these messages? [Yes/No]”

The following confirm dialogue in block 1224 is displayed if Array2[0] is greater than 8 characters, a predetermined category identifier limit used to identify valid selection data:

“OOPS your Browser just had a Cookie problem!

The following information is being ignored:”

‘Cookie fragment consisting of constructed category selection data string.’

“The corresponding items to above may have been dropped from your order!

Do you want to stop these messages? [Yes/No]”

Confirm dialogues allow the user to stop the repetition of error messages. Hidden values in the top frame control the display of the confirm dialogues. Errors that do occur are infrequent. Inclusion of the confirms make the system more reliable ensuring no selected items are dropped from an order.

Next, Array2[0] is checked in block 1225 to determine if the element contains the running subtotal data or the customer information. If any previous checks are true, then the loop counter is incremented and the next element of Array1 is considered. If all checks are false, a counter is set in block 1226 to count the number of selected items (k=0) in the category. The second element of Array2[1] is split in block 1227 with the pound sign “#” into Array3. The item counter is incremented (ii=ii+1) in block 1228. Element[k] of Array 3 is split in block 1229 with the secondary separator “!” into Array4. Array4 elements contain the selected item data. The item counter “ii” is used to store item data in block 1230 into the temporary arrays. A check is made in block 1231 to determine if all the category item data has been stored and if not, the selected item counter for the category is incremented (k=k+1). Once all selected item data for the category has been stored, a check is made in block 1232 to determine if all the cookie data has been completed. If not, the cookie counter is incremented (j=j+1) and the next element of Array1 is processed starting at block 1222.

One skilled in the art would realize that if the selection is from more than 28 categories, an additional alert will be required to inform the user of the impending category limit and to submit current selection and start a new session.

Once all item data for the remaining cookies has been stored into the temporary arrays, a counter is set (P=1) in block 1233 to display all selected items. This counter is used to get the selected item data from the temporary arrays and dynamically generate the item display format as a string in block 1234. The format of the invoice page uses the code in FIG. 4B and the format of the order picture summary uses the modified code in FIG. 2D. It should be noted that selection drop down box choices (FIG. 5C) can be integrated into the order summary pages by displaying the choices with the item description and in the pop-up tags. The display string is continually generated until the display counter “P” is equal to the item counter “ii” 1235. The document is then opened and the string is written in block 1236 thus displaying all selected items of the order.

FIG. 12C is a simplified block flow diagram for block 937 in FIG. 9C that saves item selection for an order summary page. Since selection data is saved by category, any change in item quantity requires updating the category cookie. This requires recall of category item position and remaining item data from the temporary arrays created during page generation.

First, a character data string is initialized to null in block 1240. The item position in the document is used to recall the category identifier from the temporary arrays and add it to the character string with the secondary separator “!” in block 1241. The category title is added in block 1242 to the character string plus the primary separator “#”. A loop counter is initialized p=0 in block 1243. The temporary array category identifier element[p] is compared to the category identifier of the changed item in block 1244. If it is different, the next item is considered. If the category identifiers are the same, the item position from the temporary arrays[p] and the secondary separator are added to the data string in block 1245. The item quantity from the document at position “p” and the secondary separator are added to the character string in block 1246. Next, the remaining item data from the temporary arrays[p] is added to the character string in block 1247. Item data elements are separated by the secondary separator with the last element followed by the primary separator. A check is made in block 1248 and the routine is repeated from block 1244 until all temporary array elements are considered. Next the resultant data string length is checked and an alert is issued, if the length is greater than 3000 characters in block 1249. An expiry date in block 1250 based on the current time, plus a predetermined number of weeks is calculated in milliseconds since Jan. 1, 1970. The final primary separator is removed from the data string in block 1251. The final block 1252 saves the updated category data with the document.cookie function. The cookie syntax is: the category identifier, an equal sign, the escaped data character string, “; expires=”, and the expiry date converted to Greenwich Mean Time.

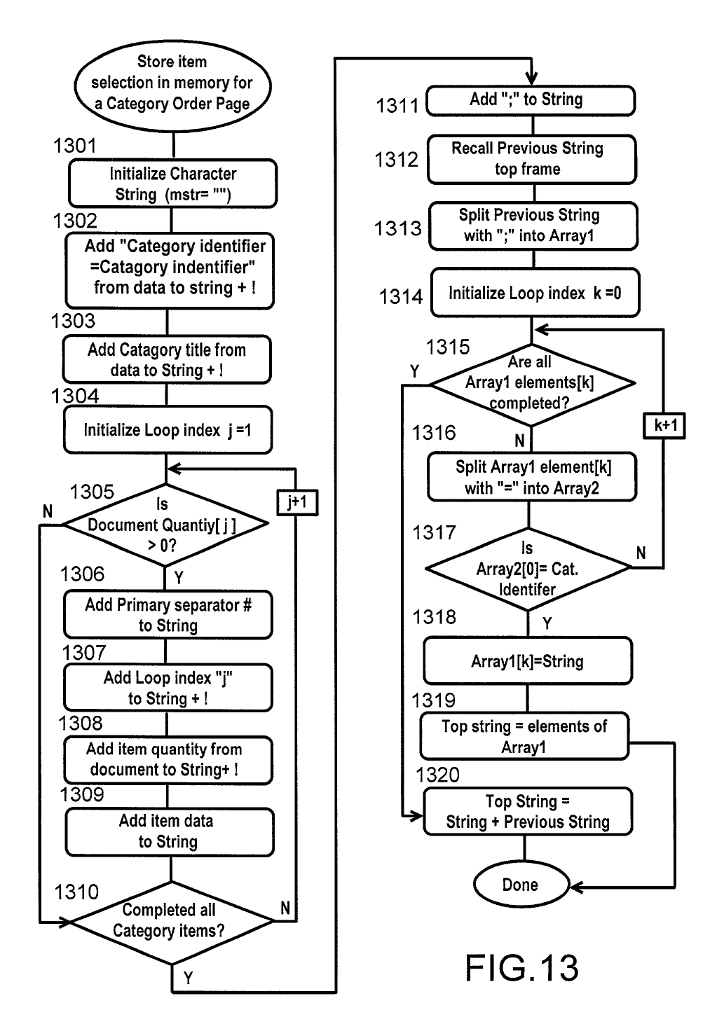

FIG. 13 is a simplified block flow diagram of an example routine for using memory to store item selection. A category order page is used for illustration. This, yet another embodiment, is useful for browsers without cookies or a disk-less computer being used for ordering. It has the advantage of being constrained only by memory rather than limitations placed on cookies. Using memory alone, item selections are not retained between browser sessions. A hidden variable in the top frame is used for the recorded data string instead of cookies.

In block 1301, a null character “string” is initialized. Block 1302 adds “category identifier category identifier” to the string. This defines the structure to allow the use of existing recall routines. However, recall routines must use the hidden variable in the top frame for this embodiment. The category title in block 1303 is added to the string. A loop index “j=1” in block 1304 is initialized.

A loop in blocks 1305-1310 builds the selected item data string for the category. The document quantity is checked in block 1305. If the quantity is greater than zero: a primary separator “#” is added to the string in block 1306; the loop index “j” denoting item position in block 1307 is added to the string; the item quantity from the document is added to the string in block 1308; and finally the item data is added to the data string delimited by the secondary separator in block 1309. If the document quantity at block 1305 not positive, then the next element is examined. The loop continues until all category items are completed in block 1310. A semicolon “;” in block 1311 is added to the string to maintain compatibility with existing recall routines. The previous string is recalled from the top frame in block 1312. It may be a null string initialized during frameset load if no items are selected. The previous string in block 1313 is split with a “;” into Array1 elements containing saved category item data. A loop index is set equal to zero in block 1314. A loop in blocks 1315-1317 places the category selections from the document into the corresponding Array1 element if it exists. First, a check is made in block 1315 to determine if all Array1 elements have been completed. If all Array1 elements have not been completed, the routine continues by splitting Array1 element[k] with an equal sign “=” into Array2 in block 1316. A check is made in block 1317 to determine if the first element of Array2[0] equals the category identifier. If false, the next Array1 element is considered at block 1315. If the check is true, items from the category have been previously selected and element Array1 [k] is replaced in block 1318 with the string generated in blocks 1301-1311. In block 1319, the top string is made equal to all the elements of Array1 and the routine exits. This handles the case where items of the category have been previously selected.

If all elements are completed in block 1315, then block 1320 sets the top string equal to string generated in blocks 1301-1311, plus the previous top string recalled from memory and the routine exits. This handles the case where no items of the category were previously selected. Similar character string manipulation routines using memory for the item description pages and order summary pages would allow the invention to function without cookies.

As further extension, a one-pixel and border-less third frame can be included into the frameset to save the data string to maintain item selections between browser sessions. The third frame document would be dynamically rewritten with the selection data string and saved as a hidden text box element initial value. Thus, the browser's page cache 841 would be used to maintain the item selections between sessions. The procedure would be to start the browser in the off-line mode loading the third frame page from the browser cache rather than initializing the page from the server. Thus, transmitting the item selection data to the vendor's server for retrieval later is more practical.

In yet another preferred embodiment, designed for marketing information, a session identity number can be assigned to each user. Selection times would be included in the category saved data and the running subtotal could be expanded to record its time history. Analysis of page download history from the vendor's server logs, combined with the enhanced recorded data, would give the vendor detailed insights on user behavior and preferences. The user can order in place, select any category at will, and readily obtain detailed information on any item, instead of the paging required to operate the current art. Analysis of this data will reflect the user's preferences directly. Revenues will be generated from the sale of this information for marketing.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

### GLOSSARY

Alert—a pop up window informing the user of a error condition

Confirm—similar to an alert including a user selection option

Cookie—a small text file written to storage that also can be transmitted to server using HTTP

Escape—placing percent “%” sign in front of special character's hexadecimal codes so that interpreter correctly identifies the character as a character and not an interpreter command. For example, escaping the string (A B C) yields (A%20B%20C) since the space character hexadecimal code is %20.

Frameset—a HTML page that divides a browser window into sub windows or frames

HTML—Hyper Text Markup Language a subset of SGML

HTTP—Hyper Text Transport Protocol

HTTPS—Secure Hyper Text Transport Protocol

Image “alt” tag—a small pop-up tag containing text

Mouse-over—the act of moving mouse pointer over HTML element on a Web page

Mouse-over preview window—an image area that presents multiple item preview images in conjunction with list format pages as the user moves the mouse pointer over the item hyperlinks

NAN—Not A Number

Objects—A special kind of variable used to organize and present data. For example: Object1 name, Object1.cost . . . ; Object2.name, Object2.cost . . .

Order-In-Place—ability to select or deselect an item(s) and view the resultant costs without having to reload browser pages or frames.

Page total—sum of the selected item quantities times their respective prices. For a category order page it is the category total. For an item description page it is the item amount. For an order summary it is the order subtotal.

Record—save or store a value

Save—record a value to storage such as magnetic hard disk

SGML—Standard Generalized Markup Language

Site navigation page—a Web containing descriptive hyperlinks to help the user to find items

Split—a string function that uses a separator to divide a string into array elements. For example, split the string “A;B;C” with “;” yields an array with element 0=A, element 1=B, and element 2=C.

Store—record a value to RAM

Tool tip—Similar to the “alt tag” but allows specification of the pop-up tag characteristics Specified transaction amounts—any order amount that vendor chooses to display. i.e. subtotal, shipping and handling, taxes, total, number of items and so on.

URL—Universal Resource Locator i.e. http:/www.company.com/

XML—eXtensible Markup Language a subset of SGML

What I claim as my invention is:

1. A method, of using a web browser for electronic shopping on a computer, that upon a selection or a change of quantity of an item on at least one order page or on at least one order summary page, calculates specified transaction amounts and records selected item data without browser load or reload. (914-924, 934-940, 955-962)

2. The method of claim 1, wherein said item refers to any product or any service, described or displayed by text, graphics, images, sound, and video, or any combination thereof.

3. The method of claim 1, wherein recorded item data is adapted a vendor's particular needs.

4. The method of claim 3, wherein said recorded item data is either temporary for order session or persistent across multiple order sessions. (1041-1052, 1141-1158, 1240-1252, 1301-1320)

5. The method of claim 3, optionally comprising a method of recording with said recorded item data, the time of making said selection or change.

6. Further to method of claim 1, upon loading any order page or any order summary page, a method that recalls the quantity of previously selected item(s) from said recorded item data and displaying said specified transaction amounts. (1020-1032, 1121-1133, 1220-1236)

7. Further to method of claim 6, wherein said specified transaction amounts are calculated using values from all said recorded item data. (930-940, 950-962)

8. Further to method of claim 1, an optional method of calculating of said specified transaction amounts for at least one order page using a running subtotal based on each change of page total. (910-924)

9. Further to the method of claim 8, a method of detecting browser error and correcting said value comprising the steps of:
a) optionally issuing an instruction for user to load a page with a calculation based on said recorded item data; and (922)
b) recording for subsequent calculations said value derived from said recorded item data. (1210)

10. The method of claim 1, wherein said order page displays of at least one item for said selection or change of item quantity.

11. The method of claim 1, wherein said order summary page, displays all selected item(s).

12. Further to method of claim 1, an optional method of providing item descriptive name, item price, and item preview image with immediate access to item detailed information.

13. The method of claim 1, further comprising a method of providing elements to access any said order page and any said order summary page.

14. Further to method of claim 1, an optional method of assigning zero price to all items, thereby effectively recording item quantity selections for subsequent completion of a transaction.

15. Further to method of claim 1, an optional method of initiating or deferring the calculation of said specified transaction amounts and recording of said selected item data until or just before browser document unload. (970)

16. A method for web pages to reduce the time required to select or change a quantity of an item comprising for quantity adjustment; an input element for each item quantity(901), hyperlinked element(s) (902, 903,225) and code segment for increment and decrement of item quantity; and further comprising, upon a single user action on said hyperlinked element the steps of:
a) determining item quantity from said input element;
b) either increments or decrements of item quantity by a predetermined amount;
c) setting item quantity to zero if it is not a positive value; and
d) displaying resultant item quantity in said input element: the steps being performed without browser load or reload.

17. Further to claim 16, wherein said single user action is a mouse click or any pointing device equivalent.

18. Further to claim 16, wherein said quantity may refer to a currency unit.

19. Further to claim 16, an optional method comprising coupling of transaction calculations to said quantity adjustment component.

20. A method, upon an order page load, comprising the steps of:
a) recalling previously selected item(s) for said order page; (910)
b) calculating and recording order page total; (911)
c) recalling a recorded value for subsequent calculations; and (912)
d) displaying specified transaction amounts; and, (913) further comprising, for selection of an item or a change of item quantity on said order page, the steps of: (915)
e) calculating and optional display of item amount; (916)
f) recording revised current item selection; (917)
g) calculating new order page total; (918)
h) calculating change in order page total; (919)
i) recording new order page total; (920)
j) addition to running subtotal of order, said change in order page total; (921)
k) optional alert for browser error (922)
l) calculating and recording a revised value for subsequent calculations; (923)
m) displaying specified transaction amounts; (924) and
n) repeating steps e) through m) for each subsequent selection or change in item quantity: the latter steps being performed without browser load or reload.

21. Further to method of claim 20, an optional list format category order page, one of a plurality of formats adapted to a vendor's needs, comprising:
A. web page elements to specify and list a plurality of items for selection with description name and price for each item; (202)
B. input element for each item quantity; (203)
C. display element for each item amount; (205) and
D. display element for said order page total. (210)

22. The claim of 21, further comprising an optional access to each item's detailed description page.

23. The claim of 21, further comprising an optional method for finding and selecting items, that displays an item preview image in a preview window (105) when the mouse pointer moves over an item description name.

24. The claim of 23, optionally comprising a method of advertising by displaying additional images in said preview window while it is not being used to display said item preview image(s).

25. The claim of 21, further comprising upon page load, an optional pictorial display of previously selected category items. (208)

26. The claim of 25, further comprising an update of said pictorial display of previously selected category items, that displays an intermediate referring page. (206)

27. The claim of 26, optionally comprising a method of advertising displaying information on said intermediate referring page.

28. The claim of 27, wherein said information is presented utilizing any web page element.

29. Further to the method of claim 20, an optional picture format category order page, one of a plurality of formats adapted to vendors needs, comprising:
A. web page elements to specify and display a plurality of items for selection with an item image for each item; (225)
B. input element for each item quantity; (226)
C. non displayed element for each item amount; and
D. display element for said order page total. (230)

30. The claim of 29, further comprising an optional access element to each item's detailed description page. (223)

31. The claim of 30, further comprising an optional display of item status information on said access element. (224)

32. The claim of 31, wherein said optional display is a mouse-over rollover image.

33. Further to the method of claim 20, an optional item detailed description order page adapted to vendors needs, one of a plurality, each comprising:
A. an item for selection with price; (311)
B. input element for item quantity; (313)
C. optional display element for item amount; (315) and
D. additional information and web page elements to display, and describe said item. (312, 317)

34. Further to the method of claim 20, wherein a vendor can choose to include any number of said optional order pages of claim 21, 29 and 33 adapted to vendors needs.

35. A method, upon a order summary page load, comprising the steps of:
a) recalling all previously selected item(s); (930)
b) optionally informing a user of detected errors if any; (1223, 1224)
c) calculating order subtotal; (931)
d) optionally recording a value for subsequent calculations; (932)
e) displaying specified transaction amounts; (933) and
f) reloading said order summary page once, using an intermediate referring page (1215) and further comprising, for a selection of an item or a change of item quantity on said order summary page, the steps of: (935)
g) calculating and optional display of said resultant item amount; (936)
h) recording said revised item selection; (937)
i) calculating said subtotal using all previously selected items for order subtotal. (938)
j) optionally recording said value for subsequent calculations; (939)
k) displaying said specified transaction amounts; (940) and
l) repeating steps g) through k) for each subsequent selection or change in item quantity: the latter steps being performed without browser load or reload.

36. Further to the method of claim 35, to complete a transaction at least one order summary page adapted to vendors needs comprising:
A. web page elements to specify and list all selected items each with an item description, and item price; (404, 405)
B. elements for adjustment of each item's quantity; (403)
C. display element(s) for item amount (s); (406)
D. display elements for all transaction amounts; (407-410)
E. an optional element to remove zero quantity entries; (411) and
F. information of additional and web page elements to complete a transaction. (413-417)

37. Further to claim 36, an optional element to access each item's detailed description page.

38. Further to claim 36, an optional method for confirming items, that displays an item preview image in a preview window (105) when the mouse pointer moves over an item description name.

39. Further to claim 38, optionally comprising a method of advertising by displaying additional images in said preview window while it is not being used to display said item preview image(s).

40. Further to claim 36, an optional method of removing zero quantity entries by using an intermediate referring page to reload said order summary page.

41. The claim of 40, optionally comprising a method of advertising displaying information on said intermediate referring page.

42. Further to claim 36, wherein a vendor may use said order summary page as an Invoice.

43. Further to the method of claim 35, an optional picture format order summary page, one of a plurality of formats, for review of items ordered comprising:
A. web page elements to specify and display all previously selected items each with an item image;
B. elements for adjustment of each item's quantity; and
C. non displayed element for each item amount.

44. The claim of 43, further comprising an optional access element to each item's detailed description page.

45. The claim of 43, further comprising an optional display of item status information on said access element.

46. The claim of 35, optionally comprising a method of advertising displaying information on said intermediate referring page during order summary page load.

47. A method, upon an order page load, comprising the steps of:
a) recalling previously selected item(s) for said order page; (950)
b) optionally calculating and displaying order page total; (951)
c) recalling all previously selected item(s) from all categories; (952)
d) optionally informing a user of all detected errors; (1064, 1065)
e) calculating order subtotal using all recalled items; (953)
f) displaying specified transaction amounts; (954) and further comprising, for a selection of an item or a change of item quantity(956) on said order page, the steps of:
g) optional calculating and displaying of said resultant item amount; (957)
h) optionally calculating and displaying order page total (958)
i) recording revised item selection; (959)
j) recalling all previously selected item(s) from all categories; (960)
k) optionally informing said user of all detected errors; (1064, 1065)
l) calculating order subtotal using all recalled items; (961)
m) displaying specified transaction amounts; (962) and
n) repeating steps g) through m) for each subsequent selection or change in item quantity:
the latter steps being performed without browser load or reload.

48. Further to method of claim 47, an optional list format category order page, one of a plurality of formats adapted to a vendor's needs, comprising:
A. web page elements to specify and list a plurality of items for selection with description name and price for each item; (202)
B. input element for each item quantity; (203)
C. optional display element for each item amount; (205) and
D. optional display element for said category order page total. (210)

49. The claim of 48, further comprising an optional element to access each item's detailed description page.

50. The claim of 48, further comprising an optional method for finding and selecting items, that displays an item preview image in a preview window (105) when the mouse pointer moves over an item description name.

51. The claim of 50, optionally comprising a method of advertising by displaying additional images in said preview window while it is not being used to display said item preview image(s).

52. The claim of 48, further comprising upon page load, an optional pictorial display of previously selected category items. (208)

53. The claim of 52, further comprising an update of said pictorial display of previously selected category items, that displays an intermediate referring page. (206)

54. The claim of 53, optionally comprising a method of advertising displaying information on said intermediate referring page.

55. The claim of 54, wherein said information is presented utilizing any web page element.

56. Further to the method of claim 47, an optional picture format category order page in, one of a plurality of formats adapted to vendors needs, comprising:
A. web page elements to specify and display a plurality of items for selection with an item image for each item; (225)
B. input element for each item quantity; (226)
C. optional non displayed element for item amount; and
D. optional display element for said category order page total. (230)

57. The claim of 56, further comprising an optional access element to each item's detailed description page. (223)

58. The claim of 57, further comprising an optional display of item status information on said access element. (224)

59. Further to the method of claim 47, an optional item detailed description order page, adapted to vendors needs, one of a plurality, each comprising:
A. an item for selection with price; (311)
B. input element for item quantity; (313)
C. optional display element for item amount; (315) and
D. additional information and web page elements to display, and describe said item. (312, 317)

60. Further to the method of claim 47, wherein a vendor can choose to include of any number of said optional order pages of claim 48, 56, and 59 adapted to vendors needs.

61. A system for electronic shopping on-line with a web browser comprising: a network (825); at least one vendor computer (810), associated with at least one vendor and comprising at least processor (811), memory (812) and web server software (815) configured to host web pages and execute transactions (817), that is connected (813) to said network; at least one client computer (830), associated with at least one user and comprising at least a processor (832), memory (833) and a web browser (840) configured to access and communicate over said network, that is connected (831) to said network; and further comprising at least one order page and at least one order summary page, in at least one browser window with or without frames, and elements configured to provide access to any page.

62. The system of claim 61, wherein said network is selected from a group consisting of, intranet, local area networks, wide area networks, and the Internet.

63. The system of claim 61, wherein a selection or change of item(s) quantity is recorded and specified transaction amounts are calculated without browser load or reload.

64. The system of claim 61, wherein said order page(s) or said order summary page(s) upon load, recall previously selected item quantities from recorded item data and display specified transaction amounts.

65. The system of claim 61, wherein said order summary page comprises: instructions and information needed to complete a transaction; and elements for transmission to said vendor.

66. The system of claim 61, wherein said vendor computer(s) optionally comprises: at least one item database (818), for at least one vendor, and a search engine for query (600-602) of said item database(s).

67. The claim of 66, wherein said query displays item(s) on order page for immediate selection of any quantity.

68. The system of claim 61, wherein said vendor computer(s) optionally comprises a customized component (820), for orders in excess of browser capability, using minimal recorded data received from said client to generate full item specification for at least one order summary page.

69. The system of claim 61, wherein said vendor computer(s) optionally comprises, for statistical marketing analysis, time logs (821) of user page downloads to be used with recorded time of making selection or change of an item.

70. An article of manufacture for use in a computer, comprising:
a portable computer medium having computer readable program code means embodied therein for a system for electronic shopping on a web browser;
code segments for at least one order page, and at least one order summary page with instructions and information needed to complete a transaction, in at least one browser window with or without frames;
code segments for a method that records, without browser load or reload, selection or change of an item quantity and displays specified transaction amounts;
code segments for a method of recalling, upon any order page or any order summary page load, the quantity of previously selected item(s) from recorded item data;
code segments for a method of displaying, upon any order page or any order summary page load, specified transaction amounts;
code segments for elements providing access to any page in said system;
optionally, code segments for at least one item database, for at least one vendor;
optionally, code segments for a search engine for at least one query of said item database(s);
optionally, code segments for said query that display item(s) on order page for immediate selection of any quantity; and
optionally, code segments for a customized component, for orders in excess of browser capability, using minimal recorded data received from said client to generate full item specification for at least one order summary page.

71. Further to article of manufacture of claim 70, wherein a client computer on-line obtains partial item information (834) from said portable computer medium and the remainder from a vendor server on a network.

72. Further to article of manufacture of claim 70, wherein said client computer off-line derives all item information from said portable computer medium and said transaction is completed by faxing or by printing and mailing said order summary page.
